(19) United States
(12) Patent Application Publication
(10) Pub. No.: US 2026/0290379 A1
(43) Pub. Date: Sep. 24, 2026

(54) SYSTEM

(71) Applicant: SoftBank Group Corp., Tokyo (JP)

(72) Inventor: Seiko OGONUKI, Tokyo (JP)

(73) Assignee: SoftBank Group Corp., Tokyo (JP)

(21) Appl. No.: 19/567,402

(22) Filed: Mar. 16, 2026

(30) Foreign Application Priority Data
Mar. 19, 2025 (JP) 2025-045121

(51) Int. Cl. G10L 25/63; G06F 40/205; G06V 40/16

(52) U.S. Cl. CPC G10L 25/63; G06F 40/205; G06V 40/176

(57) ABSTRACT

A system including a processor, wherein the processor is configured to generate a prompt instructing collection of environmental information including at least weather, atmospheric pressure, and humidity by using one or more sensors, generate a prompt instructing acquisition of profile information including at least gender, age, allergies, and chronic diseases of a user from a database, and generate a prompt instructing analysis of an emotional state of the user by analyzing at least a facial expression and a voice of the user using a camera and a microphone.

### CROSS-REFERENCE TO RELATED APPLICATION

This application is based on and claims priority under 35 USC 119 from Japanese Patent Application No. 2025-045121 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional health management systems typically consider only objective physiological or environmental parameters, such as heart rate, step count, or basic weather data, when providing health-related advice or predictions. Such systems generally do not dynamically integrate a user's emotional state, detailed profile information, and real-time environmental conditions into a unified prediction or guidance process, and therefore fail to capture complex interactions among these factors. As a result, it is difficult to accurately predict short-term changes in a user's physical condition or to provide context-aware, personalized recommendations that reflect both physical and emotional aspects of the user. Furthermore, existing systems often lack a mechanism for systematically generating prompts that instruct downstream models, including generative artificial intelligence models, to perform sophisticated prediction and recommendation tasks based on combined multimodal inputs. This leads to limited adaptability, lower prediction accuracy, and generic advice that may not sufficiently support users in taking appropriate preventive actions in daily life, such as selecting suitable meals or payment methods that match their current or predicted condition.

### SUMMARY

To solve the above problems, the invention provides a system comprising a processor configured to generate specific prompts that orchestrate the collection, analysis, prediction, and presentation of health-related information based on multiple heterogeneous data sources. In one aspect, the processor is configured to generate a prompt instructing collection of environmental information, including at least weather, atmospheric pressure, and humidity, by using one or more sensors so that real-time environmental conditions surrounding the user are obtained. In another aspect, the processor is configured to generate a prompt instructing acquisition of profile information, including at least gender, age, allergies, and chronic diseases of a user, from a database so that stable, user-specific attributes are incorporated into subsequent processing. In a further aspect, the processor is configured to generate a prompt instructing analysis of an emotional state of the user by analyzing at least a facial expression and a voice of the user using a camera and a microphone, thereby enabling recognition of the user's current emotional state as a factor influencing physical condition.

In addition, the processor is configured to generate a prompt instructing prediction of a physical condition change of the user by combining the collected environmental information, the acquired profile information, and the recognized emotional state, and by using a generative artificial intelligence model. By employing such a prompt, the generative artificial intelligence model can produce a context-aware prediction that reflects interactions among environment, profile, and emotion. Furthermore, the processor is configured to generate a prompt instructing provision of a prediction result to the user and instructing proposal of at least an optimal meal menu and a payment method to the user based on the prediction result. Through these prompts, the system enables the generation of personalized recommendations aligned with the predicted physical condition, thereby improving user support in everyday decision making and enhancing the practical value of the health management system.

The term “processor” refers to any hardware, firmware, or combination thereof, including but not limited to a central processing unit (CPU), graphics processing unit (GPU), microcontroller, or dedicated logic circuit, that is capable of executing instructions to perform the functions described in the present specification.

The term “prompt” refers to information, data, or an instruction sequence generated by the processor and provided to another module, device, or model, including a generative artificial intelligence model, that specifies a task to be performed or data to be processed, such as collection of information, analysis, prediction, or generation of recommendations.

The term “environmental information” refers to data indicative of conditions in a physical environment surrounding the user, including at least weather, atmospheric pressure, and humidity, and optionally further including temperature, precipitation, wind speed, or other environmental parameters.

The term “sensor” refers to any hardware device capable of detecting or measuring physical quantities related to environmental or user conditions, such as temperature sensors, barometric pressure sensors, humidity sensors, cameras, microphones, or other detectors, and outputting corresponding electrical signals or digital data.

The term “profile information” refers to information associated with a specific user that characterizes relatively stable attributes or conditions of the user, including at least gender, age, allergies, and chronic diseases, and optionally further including lifestyle habits, medical history, or preference information.

The term “gender” refers to an attribute of the user indicating a sex or gender identity category, including but not limited to male, female, or other self-identified categories, as stored in the profile information.

The term “age” refers to a measure of how long a user has lived, typically expressed as a numerical value representing years elapsed from the user's date of birth to a reference time.

The term “allergies” refers to one or more hypersensitivity conditions of the user in which specified substances, such as pollen, dust, or particular foods, trigger adverse physiological or immune reactions.

The term “chronic diseases” refers to one or more long-term or persistent medical conditions of the user, such as asthma, diabetes, hypertension, or migraine, which may influence the user's physical condition over time and under varying environmental or emotional states.

The term “database” refers to any structured data storage system, including relational databases, non-relational databases, or other persistent storage mechanisms, that stores profile information or related user data and allows queries and retrievals by the processor.

The term “emotional state” refers to a condition or status of the user's affect or feelings at a given time, such as happiness, sadness, stress, anxiety, calmness, or other emotional categories, recognized based on analysis of facial expressions, voice characteristics, or other behavioral signals.

The term “facial expression” refers to a visual configuration or movement of facial features of the user, including but not limited to eyes, eyebrows, mouth, and cheeks, that can be captured by a camera and analyzed to infer an emotional state.

The term “voice” refers to an acoustic signal produced by the user during speech or vocalization, including characteristics such as pitch, volume, tone, speaking rate, and prosody, that can be captured by a microphone and analyzed to infer an emotional state.

The term “camera” refers to an image capture device capable of acquiring still images or video of the user's face or body, including integrated cameras of mobile devices or external imaging devices, and outputting corresponding digital image data to the processor.

The term “microphone” refers to an audio capture device that detects sound waves, including the user's speech or vocal sounds, and converts them into electrical signals or digital audio data for processing.

The term “generative artificial intelligence model” refers to a machine learning model, such as a neural network, transformer model, or other generative model, that is configured to receive prompts and input data and to generate outputs including predicted values, textual explanations, or recommendations based on learned patterns from training data.

The term “physical condition change” refers to a variation or fluctuation in the user's physical state or health status over time, including changes in symptoms, fatigue level, pain level, or overall well-being, which may be influenced by environmental information, profile information, and emotional state.

The term “prediction result” refers to an output generated using the generative artificial intelligence model or other prediction mechanisms in response to a prompt, the output including at least an indication of a predicted physical condition change of the user and optionally additional explanatory or confidence information.

The term “meal menu” refers to a set of one or more suggested food items, dishes, or dietary compositions proposed to the user as an eating plan or recommendation that is adapted to the user's predicted physical condition, profile information, or preferences.

The term “payment method” refers to a manner or modality by which the user pays for goods or services, including but not limited to cash, credit card, debit card, electronic money, mobile payment, or other electronic settlement methods, which may be proposed based on the prediction result or user profile.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

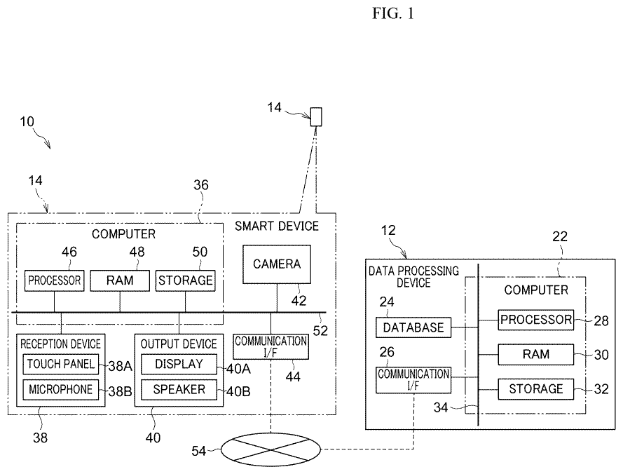

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

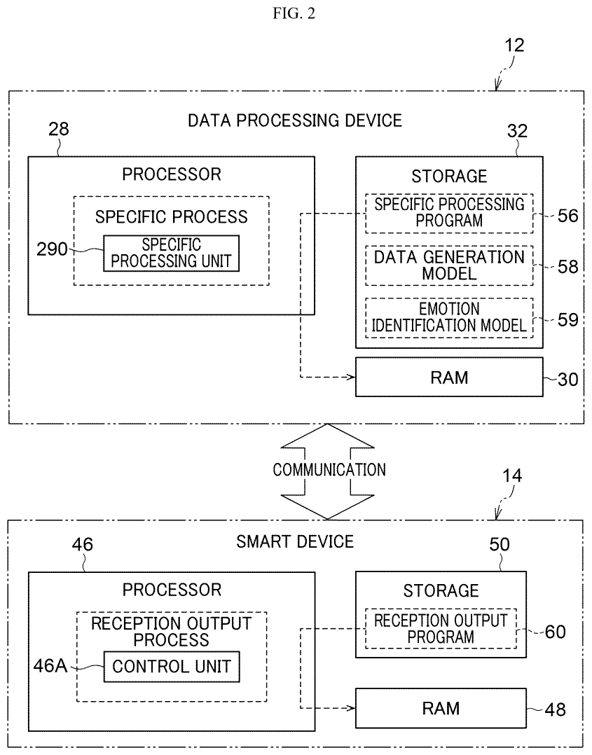

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented health support systems typically execute fixed-rule or static statistical prediction algorithms on environment data and user profile data and then present the prediction result directly to the user. Such systems suffer from several technical problems in terms of computer technology itself.

First, conventional systems generally lack an integrated mechanism for converting heterogeneous sensor signals and user attributes into machine-learning-ready feature vectors in a structured and reusable manner. Environment information, user attribute information, and emotional state information are often processed in separate subsystems with ad hoc data formats, which leads to increased processing latency, redundant data transformations, and inefficient use of processor and memory resources.

Second, conventional systems do not effectively leverage generative AI models in a way that is tightly coupled with internal prediction states of the health prediction engine. In many cases, natural language generation is performed as a loosely connected post-process, without dynamically constructing input prompt sentences from the actual prediction outputs, such as symptom type, risk level, contributing factors, and temporal context. As a result, the generated natural language explanations tend to be generic, inconsistent with the underlying prediction, and require additional computation or manual adjustment to be adapted for display on user terminals.

Third, conventional systems lack a feedback-driven loop in which user evaluation information regarding prediction accuracy and usefulness of system-generated advice is systematically captured, associated with the underlying prediction features, and used as structured training data for model re-training. Without such a closed feedback loop, the prediction model remains static or is updated only by manual offline processes, which limits the ability of the system to automatically improve prediction performance over time and to adapt to individual users based on real-world usage.

Fourth, conventional architectures do not provide a unified processor-level configuration for orchestrating: (i) multi-source acquisition of environment, user attribute, and emotional state information; (ii) feature vector generation and health state variation prediction; (iii) dynamic prompt sentence construction for a generative AI model; (iv) post-processing of the natural language response for terminal-specific presentation; and (v) collection and utilization of user evaluation information to update the prediction model. This fragmented processing causes unnecessary network traffic, duplicated computations, and inconsistent state management across different components of the system.

Therefore, there is a need for a computer-implemented system and associated processing configuration that (1) normalizes and combines environment information, user attribute information, and emotional state information into feature vectors suitable for prediction; (2) dynamically constructs prompt sentences for a generative AI model based on internal prediction outputs and user attributes; (3) post-processes the natural language response from the generative AI model in accordance with terminal display constraints; and (4) uses user evaluation information to automatically generate training data sets and re-train a prediction model, thereby improving the technical performance, adaptability, and resource efficiency of the health state variation prediction system as a whole.

The specific processing by the specific processing unit 290 of the data processing device 12 in Example 1 is realized by the following means.

The present invention provides a server comprising a processor configured to acquire environment information, user attribute information, and emotional state information via one or more information acquisition units; to convert the environment information and the user attribute information into numerical feature quantities to generate at least one feature vector; to input the feature vector into a prediction model held in a storage device to estimate health state variation information; to generate a prompt sentence for a generative information processing model based on the health state variation information and the emotional state information; to input the prompt sentence into the generative information processing model and obtain explanation information and advice information expressed in natural language; to perform post-processing on the natural language explanation information and advice information in accordance with a display format of a user terminal; to output the health state variation information, the explanation information, and the advice information to the user terminal; and to store, in association with the health state variation information, evaluation information received from the user terminal and to generate a training data set and re-train parameters of the prediction model based on the evaluation information. This enables integrated and efficient computer processing in which heterogeneous sensor and profile data are transformed into feature vectors for prediction, prediction outputs are automatically reflected in dynamically constructed prompt sentences for a generative AI model, terminal-appropriate natural language explanations are generated and displayed, and user feedback is systematically utilized to update the prediction model, thereby improving prediction accuracy, personalization capability, and overall computational performance of the health support system.

The term “environment information” refers to data representing external physical conditions around a user, including at least atmospheric conditions, pressure values, humidity values, temperature values, and other measurable environmental parameters acquired from one or more sensing devices or external data services.

The term “user attribute information” refers to data representing characteristics of a user, including at least demographic attributes such as age and gender, and health-related attributes such as allergies, chronic diseases, and other medical conditions, which are stored in or obtained from an information storage apparatus.

The term “emotional state information” refers to data representing a psychological or affective condition of a user, including at least emotion categories or scores derived from analysis of user-related signals such as facial expressions, voice characteristics, or other biometric indicators acquired by an image-capturing device or an audio input device.

The term “prediction model” refers to a computational model implemented by software or hardware logic that receives a feature vector as input and outputs health state variation information, the computational model being generated by a machine learning process or other statistical training process based on historical data.

The term “health state variation information” refers to data representing a predicted change in a user's health state over time, including at least a symptom type, a risk level, one or more contributing factors, and time-related information indicating when the predicted change is expected to occur.

The term “feature vector” refers to an ordered collection of numerical feature quantities generated by converting and encoding environment information and user attribute information into a machine-readable, fixed-dimensional representation suitable for input to the prediction model.

The term “generative information processing model” refers to a generative AI model, such as a language model implemented in software, that receives a prompt sentence or other structured input and outputs natural language text or other generated content in response to the input.

The term “prompt sentence” refers to a text sequence or structured textual input constructed to be provided to the generative information processing model, the text including at least a representation of health state variation information and user attribute information so that the generative information processing model can generate context-appropriate natural language output.

The term “explanation information” refers to natural language text generated by the generative information processing model that describes, interprets, or clarifies the predicted health state variation information, including reasons or factors contributing to a predicted health change.

The term “advice information” refers to natural language text generated by the generative information processing model that includes recommendations, cautions, or suggested actions for the user based on the health state variation information and, optionally, on user attribute information or emotional state information.

The term “user terminal” refers to an information processing apparatus used by a user, such as a mobile communication device, a portable computing device, or a stationary computing device, which is capable of communicating with the server, displaying information, and transmitting user inputs including evaluation information.

The term “evaluation information” refers to data provided from the user terminal that indicates a user's assessment of at least one of the usefulness of explanation information or advice information and the accuracy of the health state variation information, and that is used to generate training data for updating the prediction model.

In one embodiment, a server includes a processor, a memory device, a nonvolatile storage device, and a network interface. The server executes an operating system such as a general-purpose server operating system and application programs implemented, for example, using a general-purpose programming language. The server cooperates with one or more terminals operated by users. Each terminal includes at least a processor, a memory, a display device, an input device, a communication module, and optionally a camera and a microphone. The server and the terminals communicate over a communication network such as the Internet using standard network protocols.

Server uses a hardware sensor platform and external information services as environment information acquisition sources. For example, server uses one or more physical sensors for temperature, humidity, and atmospheric pressure connected through a sensor network, and uses an external weather information service accessible via an application programming interface. Server acquires raw environment signals in the form of time-stamped scalar values or small structured messages, converts them into a common internal environment information record format, and stores the records in a structured data store such as a relational database.

Terminal acquires user attribute information by presenting a user interface implemented on a mobile operating system or in a web browser. Terminal displays input fields for age, gender, known allergies, chronic diseases, and other health-related conditions. Terminal optionally acquires additional identifiers that allow server to retrieve medical record data from an external data repository, subject to user consent. Terminal validates user input locally, for example by checking input ranges and formats, and transmits the resulting user attribute information as structured data to server over a secure communication channel.

Terminal acquires emotional state information by capturing user-related signals. When terminal includes a camera, terminal captures image frames of the user's face under user control. When terminal includes a microphone, terminal captures audio signals of the user's speech. Terminal performs preprocessing such as face detection, cropping, resizing, and normalization on the image data, and performs preprocessing such as noise reduction, framing, and extraction of prosodic features on the audio data. Terminal then transmits the preprocessed image data, audio features, or derived emotion descriptors to server. In another embodiment, terminal performs local inference of emotional state using a lightweight model and transmits only emotional state information to server.

Server maintains, in memory or on storage, a prediction model for estimating health state variation information. In one embodiment, server implements the prediction model as a trained ensemble learning model using a random forest classifier or regressor. Server represents user attribute information and environment information as feature quantities. Server converts categorical attributes such as gender and disease categories into numerical encodings, for example by one-hot encoding or index-based encoding. Server normalizes continuous attributes such as age, temperature, humidity, and pressure using precomputed scaling parameters stored in the storage device. Server arranges all feature quantities in a predetermined order to construct a fixed-length feature vector. By using a predetermined mapping from feature names to indices within the vector, server can efficiently perform vectorized operations and minimize feature alignment errors.

Server processes the feature vector using the prediction model by executing a sequence of decision-tree evaluations in memory. In the case of a random forest, server executes the set of decision trees, each tree computing branch decisions based on threshold comparisons of specific feature indices. Server aggregates the outputs of the trees via majority voting or averaging, depending on whether the task is classification of specific symptom types or regression of risk scores. Server outputs health state variation information including at least a predicted symptom type, a risk score or level, and a set of contributing factors determined from feature importances or tree path analysis. This structured output is stored together with a timestamp and a model version identifier.

Server further holds a generative AI model, such as a transformer-based language model, which implements an autoregressive neural network with multiple self-attention layers. In one embodiment, server uses a generative information processing model that accepts a prompt sentence as text and produces a sequence of natural language tokens. Server does not treat this model as a generic black box; instead, server controls the model input space in a structured manner. Server generates the prompt sentence by embedding the internal prediction state, including symptom type information, risk level information, contributing factor information, and time information, as well as user attribute information such as age, gender, and disease information, into a constrained textual format.

Server, for example, constructs a prompt sentence in natural language such as:
“User profile: middle-aged female with a history of migraine and pollen allergy. Predicted symptom: migraine. Risk level: high (0.82 probability). Contributing factors: rapid drop in barometric pressure and high humidity tomorrow morning. Explain in clear and concise English how the user's health may change tomorrow and provide specific, evidence-based advice that can be practically followed at home and at work.”

Server transmits this prompt sentence to the generative AI model execution environment. The generative AI model internally represents the prompt as token embeddings, processes them through multiple transformer layers, and outputs probability distributions over tokens at each step. The model generates a sequence of tokens corresponding to explanation information and advice information. Server receives the generated token sequence, decodes it into natural language text, and performs post-processing such as truncation, removal of inappropriate phrases, and segmentation into paragraphs or bullet-like items.

Server uses a specific prompt design to tightly couple the generative AI model to the underlying prediction model. By including structured references to symptom type, risk value, and contributing factors, server ensures that the generative AI output is contextually aligned with the prediction result. This reduces the amount of post-processing required and increases consistency, thereby reducing computational load and improving the reliability of the displayed information.

Terminal receives the explanation information and advice information from server and renders them on the display in a layout adapted to the device. Terminal may show the predicted risk level as a numerical value or as a visual indicator and place the explanation text below that indicator. For example, terminal displays a message such as:
“Because the atmospheric pressure is expected to drop significantly tomorrow morning and humidity will be high, your risk of migraine is higher than usual. Consider drinking sufficient water, avoiding intense exercise early in the morning, and keeping your prescribed medication readily accessible.”

User reads the explanation information and advice information and, after observing actual physical condition over time, may provide evaluation information. For example, user may indicate that the prediction was accurate and the advice was helpful, or that no symptoms occurred despite a high predicted risk. Terminal collects such evaluation information along with identifiers of the corresponding prediction instance and transmits it to server.

Server stores evaluation information in association with the health state variation information and the feature vector used for that prediction. Server organizes this data into a training data set for updating the prediction model. In one embodiment, server labels the training samples based on user evaluation scores, for example mapping “accurate” to a positive label and “inaccurate” to a negative label for the predicted symptom outcome. Server then performs supervised learning using a machine learning library. For a random forest model, server rebuilds the forest using the expanded data set, adjusting hyperparameters such as the number of trees, maximum depth, and feature subsampling rate, and evaluates performance using metrics like accuracy, F1 score, or area under the ROC curve.

In another embodiment, server uses a neural network-based prediction model such as a multilayer perceptron. Server defines an input layer whose dimension matches the feature vector size, one or more hidden layers with nonlinear activation functions, and an output layer representing symptom probabilities or risk scores. Server trains this model using gradient-based optimization with an error function such as cross-entropy loss or mean squared error, and updates the weights according to backpropagation. Server may perform data augmentation by synthesizing additional feature vectors based on small perturbations of environment parameters or simulated user profiles to improve model robustness. In all cases, server deploys the updated model only when evaluation results indicate improved predictive performance, thereby ensuring that the system continuously improves prediction accuracy while controlling computational resource usage.

Server also uses evaluation information to adjust rules for constructing the prompt sentence. For example, server may learn that users with specific conditions prefer more concise explanations, or that including explicit references to certain environmental factors improves perceived usefulness. Server then adjusts the template used to generate the prompt sentence, such as shortening explanations for users who repeatedly provide low usefulness ratings for long texts. This adaptation is implemented as rule updates or parameterized prompt templates stored in memory, which allows server to improve communication efficiency without changing the core generative AI model.

This architecture yields technical effects beyond mere automation of human judgment. Server reduces data redundancy and processing latency by representing heterogeneous environment information, user attribute information, and emotional state information as a unified feature vector with a fixed structure. This representation is optimized for vectorized computation on a processor and for efficient storage, which improves data management and throughput. Because server operates with explicit feature indices and normalized ranges, it minimizes cache misses and enables efficient use of hardware resources, leading to faster predictions under high concurrent load.

The tight coupling between the prediction model and the generative AI model further improves computational efficiency. Instead of generating generic explanations from abstract instructions, server generates prompt sentences that directly reflect the internal prediction state, allowing the generative AI model to produce accurate and concise text with fewer tokens. This reduces processing time in the generative AI model, reduces the size of data transferred between server modules, and lowers overall communication bandwidth requirements between server and terminals.

The feedback-driven re-training loop ensures that the system's performance improves over time without relying on manual rule tuning. By converting unstructured user evaluation information into a structured training data set and automatically re-training the prediction model, server uses a machine-executed learning process that is distinct from human heuristics. This process systematically reduces prediction error, improves calibration of risk levels, and allows the model to adapt to shifting environmental patterns and user populations. From a technical perspective, the described system improves computer technology by introducing nonconventional data structures and control flows tailored to this domain. Server uses a feature vector schema that is specifically designed to integrate environment information, user attribute information, and emotional state information. This schema allows the prediction model and the generative AI model to share a coherent representation of user context. Server orchestrates these models using rule-based prompt generation and post-processing logic that are not typically present in generic computing systems. As a result, the system achieves improved prediction accuracy, lower latency, and reduced communication overhead compared with a naive architecture that separately processes data and generates explanations.

Alternative embodiments are also possible. In one variation, terminal performs at least part of the feature vector construction and transmits partially preprocessed feature data to server, thus reducing the server-side computational burden and network payload. In another variation, server uses a different type of generative AI model, such as a sequence-to-sequence model or a multilingual language model, while maintaining the same structured prompt sentence format. In yet another variation, server executes the prediction model on specialized hardware such as a graphics processing unit or a dedicated accelerator to further increase throughput.

User can apply the system in different usage scenarios. For example, user may input a prompt sentence such as:
“Based on tomorrow's weather forecast, predict how my asthma and allergies might change and give me specific advice.”
   or
“Using my profile and the current one-week weather forecast, explain on which days I am most likely to get a migraine and what preventive steps I should take.”

Terminal forwards these prompt sentences to server, which then selects appropriate time ranges and environmental data, constructs the feature vector, computes health state variation information, and generates a corresponding prompt sentence for the generative AI model that encodes the internal prediction. The system then returns explanation information and advice information aligned with the prediction. By operating in this way, the system provides a concrete and technically grounded mechanism for combining predictive computation and generative natural language processing, and for continuously improving both computational performance and user-perceived quality through structured feedback integration.

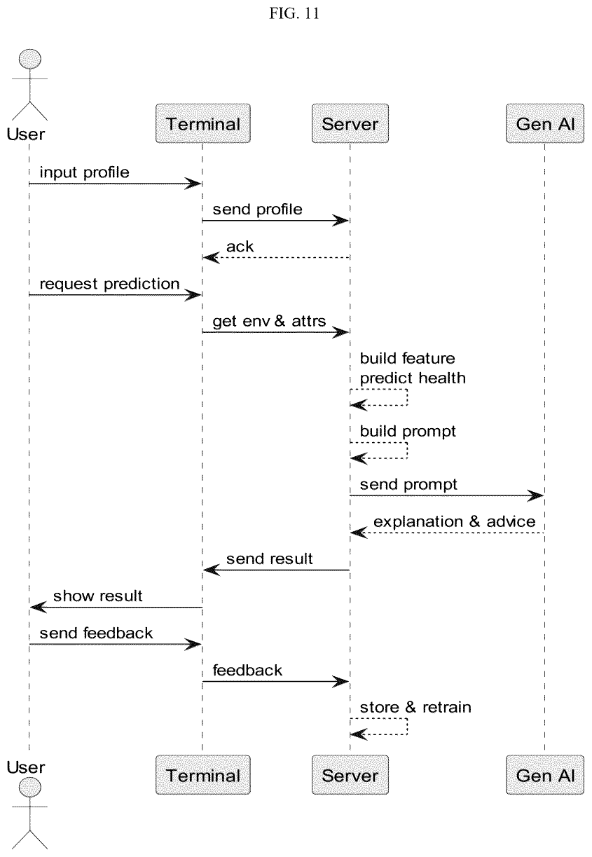

The following describes the processing flow using FIG. 11.

### Step 1:

Server acquires environment information.

Server receives, as input, raw environment signals from one or more sensors and/or external information services, including temperature values, pressure values, humidity values, and weather condition codes. Server converts sensor outputs and service responses into a unified internal record format by parsing the incoming data, converting units to standard units, and attaching timestamps and location identifiers. Server stores, as output, structured environment information records in a database for later retrieval.

### Step 2:

Terminal acquires user attribute information.

Terminal receives, as input, user-entered values such as age, gender, allergy types, and chronic disease types through a graphical user interface. Terminal validates the entries by checking data types, required fields, and allowed ranges, and converts categorical entries into standardized internal codes. Terminal sends, as output, a structured user attribute information message to server over a secure communication channel.

### Step 3:

Terminal acquires emotional state information.

Terminal receives, as input, image data from a camera and audio data from a microphone when the user consents to emotional state analysis. Terminal preprocesses the image data by detecting the face region, cropping and resizing the image, and normalizing brightness and contrast, and preprocesses the audio data by filtering noise, segmenting into frames, and extracting basic acoustic features. Terminal then either computes basic emotion descriptors locally or simply forwards the preprocessed data to server. Terminal outputs, to server, emotional state-related data or preliminary emotional state information.

### Step 4:

Server derives emotional state information.

Server receives, as input, preprocessed image data and/or audio features or preliminary emotion descriptors from terminal. Server applies an emotional state estimation algorithm, for example a trained classifier using facial expression features and prosodic features, to compute emotion categories (such as calm, stressed, anxious) and confidence scores. Server outputs structured emotional state information including an emotion label and numeric indicators, and stores it in association with the corresponding user and time.

### Step 5:

Server retrieves relevant environment information and user attribute information.

Server receives, as input, a user identifier or session identifier and, optionally, a target time range from terminal. Server queries the database to select environment information records that match the user's location and the target time period, and queries user profile tables to obtain the latest user attribute information associated with the user identifier. Server outputs combined raw data sets containing environment information and user attribute information for the subsequent feature construction.

### Step 6:

Server constructs a feature vector.

Server receives, as input, the selected environment information, user attribute information, and optionally emotional state information. Server converts categorical items (such as gender, allergy type, disease type, and weather condition) into numeric encodings by applying predefined lookup tables or one-hot encoding. Server normalizes continuous values (such as age, temperature, humidity, and pressure) using scaling parameters determined during training. Server then arranges all numeric feature quantities into a fixed-order array, thereby generating, as output, a feature vector suitable for input to a prediction model.

### Step 7:

Server predicts health state variation information.

Server receives, as input, the feature vector constructed in Step 6. Server loads or accesses a trained prediction model, such as a random forest classifier or a neural network, and feeds the feature vector to the model's inference function. Server executes numerical computations, including threshold comparisons in decision trees or matrix multiplications and nonlinear activations in a neural network, to obtain predicted outcomes. Server outputs health state variation information including predicted symptom types, risk scores or probabilities, and, optionally, contributing factor indicators derived from model-specific importance metrics.

### Step 8:

Server determines contributing factors and time information.

Server receives, as input, the model's internal outputs from Step 7 and the original environment information and user attribute information used for prediction. Server analyzes model explanations or feature importance scores to decide which environment parameters or user attributes contributed most to the predicted health state variation, and identifies the target time window for the predicted change. Server outputs enriched health state variation information that includes symptom type information, risk level information, contributing factor information, and time information.

### Step 9:

Server generates a prompt sentence for a generative AI model.

Server receives, as input, the enriched health state variation information and corresponding user attribute information, such as age, gender, and disease categories, together with emotional state information. Server builds a textual description by inserting these items into a predefined template and ordering them so that the generative AI model can interpret the context clearly. Server generates, as output, a prompt sentence that encodes the prediction results and user context, for example:
“User profile: 35-year-old female with migraine and pollen allergy. Predicted symptom: migraine. Risk level: high (0.82). Contributing factors: sharp barometric pressure drop and high humidity tomorrow morning. Based on this information, explain how the user's health might change tomorrow and provide specific preventive advice in clear English.”

### Step 10:

Server obtains explanation information and advice information from the generative AI model.

Server receives, as input, the prompt sentence generated in Step 9. Server transmits the prompt sentence to a generative AI model that implements a transformer-based neural network and requests generation of natural language text. The generative AI model performs internal tokenization, embedding, attention-weight computation, and token-by-token probability sampling, and returns a sequence of tokens representing an explanation and advice. Server decodes the tokens into text and performs post-processing such as limiting length, removing inappropriate content, and segmenting text into logically related sections. Server outputs finalized explanation information and advice information in natural language.

### Step 11:

Server prepares output data for terminal display.

Server receives, as input, the health state variation information from Step 8 and the finalized explanation information and advice information from Step 10. Server formats these items into a response structure compatible with the terminal's display layout, including fields such as symptom label, numerical risk score, textual explanation, and bullet-style advice. Server may also attach display metadata, such as severity levels mapped to colors or icons. Server outputs a structured response message for transmission to terminal.

### Step 12:

Terminal displays prediction, explanation, and advice.

Terminal receives, as input, the structured response message from server. Terminal parses the message and maps symptom labels and risk levels to specific UI components, such as title text, risk indicator graphics, and detailed text areas. Terminal renders the explanation information as multi-line text and the advice information as separate highlighted lines or list items. Terminal outputs, to user, a visual representation of predicted health state variation, reasons for the prediction, and concrete recommended actions on the display.

### Step 13:

User reviews the information and observes actual condition.

User receives, as input, the displayed prediction, explanation, and advice from terminal. User reads the information and may adjust daily behavior in response, such as preparing medication or modifying planned activities. After the relevant time period has passed, user compares the actual health condition with the prediction. User internally generates, as output, an assessment of whether the prediction was accurate and whether the advice was useful, and proceeds to provide this assessment as evaluation information.

### Step 14:

Terminal acquires evaluation information from user.

Terminal receives, as input, user operations on evaluation controls, such as button selections or rating scales, and text fields where user may enter comments, for example “The migraine occurred as predicted and the advice helped me reduce the severity” or “No headache occurred despite high risk prediction.” Terminal associates the evaluation with identifiers of the corresponding prediction and user session. Terminal outputs structured evaluation information containing scores, text comments, and prediction identifiers to server.

### Step 15:

Server stores evaluation information in association with prediction data.

Server receives, as input, the evaluation information from terminal. Server verifies the referenced prediction identifiers, retrieves the corresponding health state variation information and feature vectors, and stores the evaluation records in a dedicated data structure. Server links the evaluation information to each sample via foreign keys or index references, enabling later retrieval for training. Server outputs updated database contents where each prediction instance can be traced to corresponding user evaluation information.

### Step 16:

Server generates a training data set for model updating.

Server receives, as input, stored evaluation information and associated prediction data. Server converts qualitative evaluation labels (such as “accurate” or “inaccurate”) into numeric labels or targets suitable for supervised learning, and pairs these labels with the original feature vectors used for each prediction. Server may filter or weight samples based on evaluation reliability or recency. Server outputs one or more training data sets consisting of input feature vectors and corresponding target labels.

### Step 17:

Server re-trains or updates the prediction model.

Server receives, as input, the training data sets generated in Step 16 and the current parameters of the prediction model. For an ensemble model, server rebuilds or fine-tunes decision trees by fitting them to the training data sets and adjusting parameters such as splitting criteria and tree depth to minimize prediction error metrics. For a neural network model, server performs gradient-based optimization using the training data sets, computes loss values such as cross-entropy or mean squared error, and updates model weights using backpropagation. Server evaluates the updated model on a validation subset and compares its performance to the previous version. When the updated model shows improved accuracy or calibration, server stores, as output, the new model parameters and activates the updated model for subsequent predictions.

### Step 18:

Server adjusts prompt sentence generation rules based on evaluation statistics.

Server receives, as input, aggregated statistics derived from evaluation information, such as average usefulness scores for explanations of particular length or content style. Server analyzes correlations between user evaluation and prompt structure, such as whether including explicit factor explanations increases satisfaction for certain user groups. Server modifies rules or templates used in Step 9, for example by shortening explanations for users who consistently prefer concise output or by adding more detailed factor descriptions for users who rate detail-rich explanations more highly. Server outputs updated prompt generation rules, which are applied in future prompt sentence generation to improve alignment between generated text and user preferences.

### Step 19:

Server, terminal, and user continue interactive operation.

User provides, as input, new prompt sentences through terminal, such as “Explain how this week's humidity and pressure will affect my migraines and what I should do each day.” Terminal forwards the prompt sentences and context identifiers to server. Server uses the prompt sentences to select relevant time ranges and environment information, constructs new feature vectors, predicts health state variation information with the current prediction model, generates updated prompt sentences for the generative AI model based on the new predictions, and obtains new explanation and advice texts. Terminal displays the new results to user. Through this repeated cycle, the system continuously refines its internal models and prompt sentence rules, thereby producing, as output, increasingly accurate and computationally efficient predictions and explanations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for meal selection typically rely on static user profiles or simple rule-based logic and do not fully exploit dynamic environmental conditions, emotional states, and predictive health modeling. In many implementations, a server separately acquires environmental data, retrieves user attribute data, and presents preconfigured menus, but these processes are loosely coupled, manually curated, and not optimized as an integrated, automated computation pipeline. As a result, such systems often generate meal recommendations that are generic, poorly personalized, and not aligned with short-term biological state variations of the user.

Furthermore, existing systems that attempt to use machine learning or generative artificial intelligence models usually treat these models as black-box add-ons. Input sentences for such models (prompt sentences) are frequently crafted in an ad hoc manner by human designers or by simple string concatenation without systematic control of feature selection, constraint encoding, or dynamic adjustment based on behavioral history. This leads to several technical problems: (i) inefficient utilization of computational resources due to redundant or irrelevant input information, (ii) unstable or inconsistent quality of generated recommendations, and (iii) difficulty in scaling the system to handle many users with diverse contexts in real time. In addition, conventional user interface flows do not coordinate prediction of biological state variation with a structured transformation into machine-readable and machine-generatable representations. Environmental information, user attribute information, and multimodal input such as facial expressions and voice are often processed in silos, causing increased latency and duplicated processing, and preventing effective optimization of communication bandwidth and storage usage. The lack of a unified mechanism to convert these heterogeneous inputs into structured feature sets, prediction data, and controlled prompt sentences for a generative artificial intelligence model results in a suboptimal computer-implemented architecture.

Accordingly, there is a need for a computer-implemented technique that improves the overall operation of the server-side processing pipeline by: (1) automatically coordinating acquisition and structuring of environmental information and user attribute information; (2) integrating multimodal recognition of emotional state; (3) performing predictive computation of biological state variation; and (4) programmatically generating prompt sentences with constraint conditions and preference conditions for a generative artificial intelligence model. By doing so, the system can reduce manual configuration, enhance consistency and relevance of generated meal proposals, and improve efficiency and scalability of the underlying computational resources, thereby improving the functioning of the computer system itself rather than merely implementing a business or dietary guideline in software.

The specific processing by the specific processing unit 290 of the data processing device 12 in Application Example 1 is realized by the following means.

The present invention provides a server comprising a processor and a storage resource, the processor being configured to execute instructions that cause the server to generate instruction information to start an acquisition process of environmental information by a sensing resource, acquire environmental information including at least weather information, pressure information, and humidity information via a communication path or a detection resource based on the instruction information, and store the environmental information in a structured data format in the storage resource; generate instruction information to start an acquisition process of user attribute information stored in the storage resource, acquire user attribute information including at least gender information, age information, allergy information, and medical condition information based on the instruction information, and store the user attribute information in association with identification information in the storage resource; generate instruction information to start a collection process of facial expression information and voice information of a user by an imaging resource and an audio acquisition resource, acquire the facial expression information and the voice information based on the instruction information, and execute a recognition process on the facial expression information and the voice information to identify an emotional state of the user; generate a feature set based on the environmental information and the user attribute information, provide input data including the feature set and the emotional state to a machine learning model, and execute a computation process to calculate prediction information regarding a biological state variation of the user; generate description text including constraint conditions and preference conditions relating to nutrient intake based on the prediction information regarding the biological state variation and the user attribute information, and create a prompt sentence including the description text; input the prompt sentence to a generative artificial intelligence model, obtain meal candidate information from the generative artificial intelligence model, analyze the meal candidate information to generate meal proposal information including a plurality of meal options and respective main components in a structured format, and transmit the meal proposal information to a display terminal; and generate presentation control information to cause the display terminal that has received the meal proposal information to visually present the meal options in a selectable form to the user. This enables an integrated, computer-implemented pipeline that automatically transforms heterogeneous sensor data and user data into structured feature sets, performs predictive health computation, and dynamically generates and controls prompt sentences for a generative artificial intelligence model, thereby improving the efficiency, scalability, and technical reliability of meal recommendation processing executed by the server.

The term “environmental information” refers to data representing physical conditions of a user's surrounding environment, including at least weather-related parameters such as weather condition, atmospheric pressure, and humidity, and optionally additional contextual parameters such as temperature, time, or geographic location.

The term “user attribute information” refers to data representing personal attributes of a user, including at least gender, age, allergy status, and medical condition, and optionally additional profile-related parameters such as lifestyle, dietary preferences, or activity level.

The term “sensing resource” refers to a hardware or software resource configured to acquire environmental information, including but not limited to a sensor device, a sensor network, or an external information service accessible via a communication network.

The term “detection resource” refers to a hardware component or module configured to directly detect physical quantities related to the environment, such as a pressure sensor, a humidity sensor, a temperature sensor, or a combined environmental sensor.

The term “communication path” refers to a logical or physical communication channel used to transmit data between the server and an external resource, including wired or wireless networks, and supporting protocols such as internet protocols or local communication protocols.

The term “storage resource” refers to any memory or data storage element used to store environmental information, user attribute information, prediction information, or meal proposal information, including volatile memory, non-volatile memory, or external database systems.

The term “identification information” refers to data that uniquely or semi-uniquely identifies a user or a user account within the system, including but not limited to user IDs, device IDs, session IDs, or other identifiers.

The term “imaging resource” refers to a hardware or software component configured to capture visual information related to the user, such as a camera, an image sensor, or an image acquisition module.

The term “audio acquisition resource” refers to a hardware or software component configured to capture audio information related to the user, such as a microphone, an audio sensor, or an audio acquisition module.

The term “facial expression information” refers to visual data or derived features representing a user's facial movements or expressions captured by the imaging resource, which can be used to infer emotional or psychological states.

The term “voice information” refers to audio data or derived features representing a user's spoken voice, tone, or prosody captured by the audio acquisition resource, which can be used to infer emotional or psychological states.

The term “emotional state” refers to a classification or representation of a user's affective condition, such as stress level, happiness, sadness, or calmness, determined through analysis of facial expression information, voice information, or other behavioral signals.

The term “feature set” refers to a structured collection of numerical or categorical values derived from environmental information, user attribute information, and optionally other inputs, which is formatted as input for a machine learning model.

The term “machine learning model” refers to a computational model that has been trained using sample data to perform predictive or classification tasks, including but not limited to regression models, classification models, decision-tree-based models, neural networks, or ensemble models.

The term “prediction information regarding a biological state variation” refers to data representing an estimated or forecasted change in a user's biological or health-related condition, such as risk of illness, fatigue level, or hydration status, as computed by the machine learning model.

The term “description text” refers to human-readable text generated by the processor that encodes constraint conditions, preference conditions, and contextual information to be provided as part of a prompt to a generative artificial intelligence model.

The term “constraint conditions” refers to conditions that limit or restrict the space of acceptable outputs from the generative artificial intelligence model, such as prohibiting certain ingredients due to allergies, restricting salt content, or imposing preparation time limits.

The term “preference conditions” refers to conditions that express desired characteristics of the outputs from the generative artificial intelligence model, such as preferred flavors, cooking styles, nutritional targets, or cultural preferences.

The term “prompt sentence” refers to a sequence of natural language text or equivalent structured input that is provided to a generative artificial intelligence model to specify a task, context, constraints, and preferences for generating an output.

The term “generative artificial intelligence model” refers to a computational model configured to generate text or other content in response to an input prompt, such as a generative language model, a transformer-based model, or another content-generating model trained on large datasets.

The term “meal candidate information” refers to data output by the generative artificial intelligence model that describes one or more candidate meals, including elements such as meal names, ingredients, preparation suggestions, or health-related explanations.

The term “meal proposal information” refers to structured data derived from the meal candidate information, including a plurality of meal options and respective main components, formatted for storage, processing, and presentation to the user.

The term “main components” refers to principal elements or ingredients of a meal option, such as primary food items, key nutritional elements, or dominant flavor components that characterize the meal.

The term “display terminal” refers to an information processing device having a display function, such as a mobile terminal, a tablet, a personal computer, or another user interface device, configured to present meal proposal information to the user.

The term “presentation control information” refers to data or control signals generated by the processor to instruct the display terminal on how to visually present meal proposal information, including layout, selection mechanisms, and association with explanatory text.

The term “user behavior history information” refers to data representing past actions of the user within the system, including but not limited to previously selected meals, feedback, ratings, or interaction logs, which can be used to adjust future prompt sentences or recommendations.

In one embodiment, a server, a terminal, and at least one sensing resource cooperate to implement the invention. The server includes a processor, a memory, a network interface, and a non-transitory storage resource such as a relational database. The terminal includes a processor, a display, an input interface such as a touch panel, and a network interface. The sensing resource includes at least one environmental sensor device and/or an external information providing system accessible via a communication path.

The server operates on a general-purpose computing platform, such as a rack-mounted computer or a virtual machine in a cloud computing environment, executing an operating system and an application stack that includes a web framework, a database management system, and one or more machine learning libraries. In one example, the server uses an operating system such as a general-purpose server operating system, a database system such as a relational database engine, and a machine learning toolkit such as a numerical computation library and a machine learning library. The server also uses a neural network framework capable of constructing and training deep neural network models.

The terminal operates on a mobile computing platform, such as a smartphone or tablet, executing a mobile operating system and an application program. The terminal presents graphical user interfaces to the user, acquires user attribute information and feedback data, and displays meal proposal information received from the server. The terminal communicates with the server over a wireless network using a secure communication protocol.

The server uses the sensing resource to obtain environmental information. In one example, the sensing resource includes an external information providing system that exposes an application programming interface (API). The server transmits a request for environmental information through the network interface and receives a response including data representing weather condition, atmospheric pressure, humidity, and optionally temperature and location. The server parses the response, converts it into a normalized internal data structure, such as a table of environmental records with fields for timestamp, location, and measured values, and stores the records in the storage resource.

In another example, the sensing resource includes a set of on-site environmental sensors, such as a temperature sensor, a humidity sensor, and a barometric pressure sensor, connected through a gateway device. The server receives data packets from the gateway, validates and decodes the sensor readings, and inserts the sensor readings into the storage resource. By supporting both external information providing systems and local sensor devices, the server can flexibly adapt to different deployment environments. The terminal enables the user to enter user attribute information. The terminal displays input forms including fields for gender, age, allergy status, medical conditions, dietary preferences, and lifestyle preferences. The terminal performs client-side validation, such as range checks and type checks, and transmits the user attribute information in a structured format to the server. The server receives the user attribute information, associates it with identification information such as a user identifier, and stores it in the storage resource. The server may further transform the user attribute information into normalized representations, for example, encoding allergy types as categorical codes and mapping medical conditions to standardized codes.

The server also acquires multimodal information related to the user's emotional state. The terminal activates an imaging resource and an audio acquisition resource, such as a camera and a microphone of the terminal. The terminal captures facial expression information and voice information of the user and transmits these data streams or extracted feature data to the server. The server applies signal processing and pattern recognition algorithms to the incoming visual and audio data. For facial expression information, the server may apply a convolutional neural network (CNN) architecture, including multiple convolution layers, pooling layers, and fully connected layers, trained on facial expression datasets to classify basic emotions such as happiness, sadness, anger, or stress. For voice information, the server may extract acoustic features such as Mel-frequency cepstral coefficients (MFCCs), pitch, and energy, and then apply a recurrent neural network (RNN) or a transformer-based audio classifier to infer an emotional state. The server then stores the determined emotional state as part of the user's state history.

The server constructs a feature set by combining environmental information, user attribute information, and emotional state information. The feature set includes numerical features such as temperature, humidity, age, and continuous scores, as well as categorical features such as weather condition, allergy types, medical conditions, and emotional categories. The server encodes categorical features using techniques such as one-hot encoding or embedding representations. The server normalizes or scales numerical features to improve the stability and convergence of machine learning models.

The server applies a machine learning model to the feature set to compute prediction information regarding a biological state variation of the user. In one embodiment, the machine learning model includes a gradient-boosted decision tree ensemble that predicts risk scores for conditions such as likelihood of catching a cold, level of fatigue, or risk of dehydration. In another embodiment, the machine learning model includes a deep neural network, for example, a feedforward network with multiple hidden layers, rectified linear unit (ReLU) activation functions, batch normalization layers, and dropout layers to reduce overfitting. The server loads pre-trained model parameters from the storage resource into memory and performs forward propagation computations to determine the prediction output. The server trains these models offline using historical datasets that include environmental records, user attribute records, emotional state labels, and observed health outcomes. The server minimizes a loss function appropriate for the prediction task, such as cross-entropy loss for classification of health risk categories or mean squared error for regression of risk scores. During training, the server updates model parameters using an optimization algorithm such as stochastic gradient descent or an adaptive optimizer. The server may apply data augmentation techniques, such as synthetic variation of environmental conditions or noise injection in input features, to improve robustness. The server periodically retrains or fine-tunes the model using newly accumulated user data to adapt to changing conditions. Based on the prediction information regarding the biological state variation and the user attribute information, the server generates description text that encodes constraint conditions and preference conditions. The server programmatically constructs this description text using template-based generation and rule-based inclusion of specific constraints. For example, if the user has an allergy to shrimp and the model predicts an increased risk of catching a cold, the server inserts constraints such as “avoid all shellfish ingredients” and “include ingredients supporting immune function,” and preference conditions such as “easy to cook within 30 minutes.” Because these constraints are generated from structured features and prediction outputs rather than manually written, the server can adaptively craft tailored conditions for many users in real time, which would be infeasible for human operators.

The server then creates a prompt sentence by combining: (i) a summary of the current environmental context, (ii) a summary of user attributes, (iii) a representation of the predicted biological state variation, and (iv) the constraint conditions and preference conditions in a consistent natural language format. This prompt sentence is provided as input to a generative AI model, such as a transformer-based language model with multiple attention layers and feedforward sublayers. The generative AI model has been pre-trained on large text corpora and optionally fine-tuned on domain-specific dietary and nutritional texts. The server sends the prompt sentence over a secure API to a model execution environment running on specialized hardware, such as a graphics processing unit cluster or a tensor processing unit accelerator.

In one concrete example, the server generates a prompt sentence such as:
“Current weather is rainy with low temperature and high humidity. The user is a 30-year-old person who easily catches colds and has no food allergies or chronic diseases. Based on this situation, please act as a nutritionist and propose three optimal dinner menus that help boost the immune system. Each menu should use common ingredients available in supermarkets, be easy to cook at home within 30 minutes, and include a brief explanation of why it supports immunity. Output the result as:
1) Menu name
2) Main ingredients
3) Short health explanation.”

In another example, the server generates a prompt sentence such as:
“Current weather: hot and humid. User profile: 45-year-old female, has hypertension, no allergies. Based on the predicted increased risk of fatigue and dehydration, propose three low-salt, high-potassium meal menus that support hydration and are suitable for dinner. List each menu with main ingredients and brief health benefits.”

The server receives generated text from the generative AI model as meal candidate information. The server parses the generated text, using pattern-based extraction or natural language parsing, to identify meal names, ingredient lists, and explanatory descriptions. The server converts the extracted information into structured meal proposal information, such as records containing a meal identifier, title, list of main components, preparation notes, and health-related rationale. The server stores this structured information in the storage resource and prepares a response message.

The server transmits the meal proposal information to the terminal. The terminal receives the structured data, constructs graphical elements such as cards or list items, and displays the meal options in a selectable form. The terminal may show icons or labels indicating that a meal supports immunity, is low in salt, or helps with hydration. The user selects a meal option via touch input. The terminal may then request more detailed instructions or may store the user's choice as feedback information.

The server uses user behavior history information, such as previously selected meals and explicit feedback, to dynamically modify subsequent prompt sentences. For example, if the user consistently avoids certain suggested ingredients, the server decreases the probability of including those ingredients in future prompt constraints. The server integrates this behavior history as additional features in the feature set and may adjust constraint conditions or preference conditions in the description text. This closed-loop adaptation allows the system to improve recommendation accuracy and user satisfaction over time.

From a technical perspective, the described architecture improves computer technology in several ways. The server does not merely automate a human nutritionist's decision-making process. Instead, the server implements a specific data flow and control mechanism that transforms heterogeneous, high-dimensional inputs into optimized inputs for a generative AI model and back into structured outputs. By pre-structuring environmental information and user attribute information into feature sets and by computing biological state variation predictions before constructing the prompt sentence, the server reduces the amount of unstructured context that must be encoded in the prompt, thereby reducing token length and communication overhead with the generative AI model. This reduces latency and computational resource use in the model execution environment.

The integration of a separate predictive model for biological state variation before prompting the generative AI model also increases the precision and stability of the system. Instead of relying on the generative AI model to implicitly infer health risks from free-form text, the server injects explicit risk scores and classifications derived from a supervised learning model trained on labeled health data. This hybrid architecture leverages strengths of both discriminative and generative models and leads to improved accuracy and consistency of the generated meal proposals.

The server further improves data management by storing environmental records, user attribute records, emotional state classifications, prediction information, and meal proposal information in normalized relational tables with defined schemas. This structure facilitates efficient indexing, querying, and caching, which is particularly important when serving large numbers of users. The use of well-defined feature encodings and prompt construction rules allows the server to cache intermediate representations and reuse them, thereby reducing repeated computation.

Because the server uses deep neural network architectures for both emotional state recognition and biological state variation prediction, the server can learn complex, nonlinear relationships that humans would not easily define as static rules. For example, the server can learn interactions between humidity levels, temperature fluctuations, user age, and certain medical conditions that affect risk of respiratory issues. By encoding these relationships in learned weights and using them to drive prompt content, the server generates technically optimized inputs to the generative AI model that a human prompt designer would not practically construct at scale.

The server may employ alternative architectures and configurations. In one alternative embodiment, the machine learning model for biological state variation is implemented as a recurrent neural network that processes sequences of past environmental and emotional states to capture temporal patterns. In another embodiment, the generative AI model is hosted locally on the same hardware as the server, reducing network latency and enabling more granular control over resource allocation. In yet another embodiment, the server partitions computation across multiple nodes, using a load balancer to distribute prediction and prompt-generation tasks based on current load, thereby improving scalability.

The terminal may also vary in configuration. In one embodiment, the terminal is a wearable device with an integrated display and sensors, such as a smartwatch, which directly measures physiological signals like heart rate or skin temperature. The terminal transmits these additional signals to the server, and the server incorporates them into the feature set for more accurate biological state variation predictions. In another embodiment, the terminal operates as a web client within a browser, where the graphical user interface is rendered via web technologies but the overall data flow remains the same.

Because the system utilizes a specific combination of structured feature generation, predictive modeling, rule-based prompt construction, and generative AI usage, the computer system achieves improvements in processing speed, accuracy of personalized recommendations, reduction of network load between the server and the generative AI execution environment, and reduction of manual configuration effort. These improvements arise from the particular data structures and control logic employed, not merely from using a generic computer or generic AI model. As a result, the invention provides a concrete technical solution that improves the functioning of the server and associated devices in generating context-aware, health-based meal proposals.

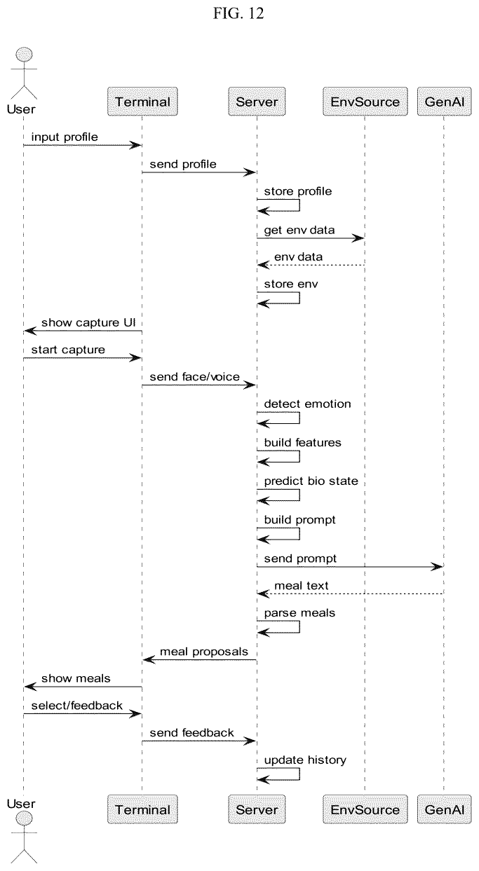

The following describes the processing flow using FIG. 12.

### Step 1:

The server acquires environmental information from a sensing resource. The server uses a network interface to send a request to an external information providing system or to receive data packets from local environmental sensors. The input of Step 1 is raw environmental data including at least weather condition, atmospheric pressure, and humidity, and optionally temperature and location. The server parses the incoming data format (for example, JSON or binary packets), validates ranges and units, converts the data into an internal record structure with fields such as timestamp, location identifier, and measured values, and writes these records into a storage resource. The output of Step 1 is a set of normalized environmental records stored in a database table.

### Step 2:

The terminal acquires user attribute information from the user. The terminal displays an input screen with fields for gender, age, allergy status, medical conditions, and dietary preferences. The input of Step 2 is the user's manual entries and selections on the touch screen or other input interface. The terminal performs validation, such as checking that the age field contains a numeric value within a valid range and that required fields are not empty. The terminal converts the validated entries into a structured data object including key-value pairs for each attribute and transmits this object to the server over a secure communication channel. The output of Step 2 is a user attribute information payload sent from the terminal to the server.

### Step 3:

The server stores and normalizes user attribute information. The server receives the user attribute information payload from the terminal via an application programming interface and verifies the user's identification information, such as a session token or user ID. The input of Step 3 is the structured user attribute payload. The server maps free-text or enumerated fields to normalized codes, for example, encoding allergy types as categorical codes and mapping medical conditions to standardized identifiers. The server then inserts or updates a record in a user profile table, associating the normalized attributes with the user's identifier. The output of Step 3 is a consistent, normalized user profile record stored in the database.

### Step 4:

The terminal acquires multimodal emotional data from the user. The terminal activates an imaging resource and an audio acquisition resource, such as a camera and a microphone, after obtaining necessary permissions. The input of Step 4 is visual data of the user's face and audio data of the user's voice captured during a short recording interval. The terminal may optionally perform local preprocessing, such as compression or basic feature extraction, and then transmits the visual and audio data streams or feature representations to the server. The output of Step 4 is a set of captured facial expression information and voice information delivered to the server.

### Step 5:

The server determines an emotional state of the user. The server receives the facial expression information and voice information as input in Step 5. The server applies an image recognition module, for example based on a convolutional neural network, to the facial images, extracting features such as facial landmarks and expression-related activations. The server also applies an audio analysis module, for example based on a recurrent or transformer-based network, to extracted audio features such as Mel-frequency cepstral coefficients, pitch contours, and energy. The server fuses the visual and audio features, for example by concatenation or weighted averaging, and inputs them into an emotion classification model. The model performs data computations including matrix multiplications and nonlinear activations to output probabilities for predefined emotion categories. The server selects the category with the highest probability as the current emotional state and writes this label and associated confidence score into an emotional state history table. The output of Step 5 is an emotional state label associated with the user and stored in the database.

### Step 6:

The server constructs a feature set for biological state prediction. The server retrieves, as input, the latest environmental records, the normalized user profile record, and the most recent emotional state label for the user from the storage resource. The server then performs data processing to convert these inputs into a machine learning feature vector. The server encodes categorical attributes, such as weather condition, allergy codes, medical condition identifiers, and emotional state category, using one-hot encoding or embeddings, and scales numerical attributes, such as age, temperature, humidity, and pressure, using normalization or standardization. The server concatenates all encoded attributes into a fixed-length feature vector. The output of Step 6 is a structured feature set ready for input to a predictive model.

### Step 7:

The server predicts biological state variation. The server takes the feature set from Step 6 as input and feeds it into a machine learning model for health risk prediction. The server loads the model parameters from storage and performs forward computation, such as propagating the feature vector through multiple layers of a neural network or through an ensemble of decision trees. During this computation, the server executes operations including weighted sums, activation functions, and tree-based decision evaluations. The model outputs one or more prediction values, such as a probability of catching a cold, a fatigue score, or a dehydration risk score. The server then maps these numeric outputs to semantic categories, such as “high risk of cold” or “moderate fatigue risk,” and records these predictions in a prediction history table. The output of Step 7 is prediction information regarding a biological state variation of the user.

### Step 8:

The server generates constraint and preference description text. The server uses, as input, the prediction information from Step 7 and the user attribute information from the profile record. The server applies rule-based logic to determine constraints, such as excluding ingredients corresponding to known allergies, limiting salt for certain medical conditions, or emphasizing immune-supportive ingredients when cold risk is high. The server also determines preference conditions based on user preferences, such as preferred cuisine type or maximum cooking time. The server composes human-readable description text that explicitly states these constraint conditions and preference conditions, for example by filling template sentences and inserting parameter values. The output of Step 8 is description text that encodes structured constraints and preferences in natural language.

### Step 9:

The server constructs a prompt sentence for a generative AI model. The server uses, as input, the environmental information, the user attribute summary, the emotional state label, the biological state prediction categories, and the description text generated in Step 8. The server combines these elements into a coherent natural language prompt sentence with a defined format, including explicit instructions, desired output structure, and task role. The server may segment the prompt into sections such as “Context,” “User profile,” “Predicted health state,” and “Task instructions,” and then concatenates them into a single string. The output of Step 9 is a complete prompt sentence suitable for input to the generative AI model.

### Step 10:

The server obtains meal candidate information from the generative AI model. The server sends the prompt sentence from Step 9 as input to the generative AI model through an API call. The generative AI model executes on specialized hardware and returns generated text. The server receives this generated text as raw meal candidate information, which may include several meal names, lists of ingredients, and explanations. The server parses the generated text using string pattern recognition or natural language parsing to identify discrete meal units, extract main components, and separate explanation sections. The output of Step 10 is a set of structured representations of meal candidates extracted from the generated text.

### Step 11:

The server generates meal proposal information for presentation. The server uses, as input, the structured meal candidate representations from Step 10. The server organizes them into a standardized internal format, such as records with fields for meal identifier, menu name, main components, nutritional tags, and health explanations. The server may perform additional computations, such as ranking meals based on alignment with prediction information, variety of ingredients, or past user behavior history. The server then packages the top-ranked meal options into a response object designated as meal proposal information and stores a copy in the storage resource for logging and future analysis. The output of Step 11 is a structured meal proposal information object ready to be sent to the terminal.

### Step 12:

The terminal presents the meal proposal information to the user. The terminal receives, as input, the meal proposal information from the server via the network interface. The terminal parses the structured data and generates graphical user interface components, such as a scrollable list or grid of cards, each card showing a meal name, a list of main components, and a brief health explanation. The terminal arranges these components on the display and assigns interaction handlers so that the user can tap or select items. The output of Step 12 is a visually rendered set of selectable meal options on the terminal's display.

### Step 13:

The user selects a meal option and provides feedback. The user views the meal options displayed by the terminal and, as input, selects one or more options by tapping or clicking, and optionally provides feedback such as “like,” “dislike,” or rating values. The terminal records the selection and feedback and transmits them back to the server as user behavior history information. The output of Step 13 is a user behavior history record captured and sent to the server.

### Step 14:

The server updates behavior history and adjusts future prompt generation. The server receives, as input, the user behavior history information from Step 13. The server appends this information to a behavior history table and may aggregate it to compute derived features, such as ingredient preferences or acceptance rates for certain dietary patterns. The server then uses these derived features in future executions of Step 6 and

Step 8, incorporating them into the feature set and into the rule-based generation of constraint and preference description text. By doing so, the server modifies the content and specificity of future prompt sentences and adjusts the selection of meal candidates returned by the generative AI model. The output of Step 14 is an updated model of user behavior that influences subsequent prediction and prompt generation, thereby closing the adaptation loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional health advisory systems that rely on computerized processing often treat environmental data and user profile data in a fragmented manner, or use static rule sets that are manually defined and difficult to maintain. As a result, such systems suffer from several technical problems: (i) environmental information such as weather, atmospheric pressure, and humidity, which is obtained from heterogeneous external sources, is not normalized or structured in a way that allows efficient machine processing; (ii) user profile information such as gender, age, allergy information, and chronic disease information, which is acquired from multiple terminals, is not securely integrated with the environmental information in a uniform feature representation suitable for machine learning; (iii) the generation of prediction input data and the execution of health condition variation prediction are often implemented in ad hoc application logic, leading to high computational overhead, redundant data transformations, and difficulty in re-using or retraining predictive models; and (iv) messages presented to users are typically generated from fixed templates, which limits the system's ability to adaptively explain prediction results in natural language while taking into account both environmental conditions and individual user profiles.

From a computer technology perspective, these shortcomings manifest as inefficiencies and limitations in how processors, storage devices, and software components cooperate to perform prediction tasks. In particular, existing systems do not define a unified processing pipeline in which a processor systematically: (a) acquires and stores environmental information and personal profile information in a normalized, machine-usable format; (b) converts heterogeneous data into numerical feature vectors through standardized preprocessing; (c) applies a learned machine learning model to compute a quantitative health risk index or category; and (d) generates, possibly with the aid of a generative artificial intelligence model, dynamically tailored warning or advice messages in a form directly usable by terminals. This lack of integrated architectural design results in increased latency, inconsistent prediction quality, reduced scalability for large numbers of users or large volumes of environmental data, and difficulty in updating or improving the predictive behavior without extensive changes to the underlying code base.

Furthermore, known techniques for providing health-related notifications often do not leverage historical prediction results as systematically managed data for retraining of machine learning models. Without an explicit mechanism for storing prediction histories as structured data in a storage device and feeding such histories back into a training workflow, the system cannot continuously optimize prediction performance in response to evolving environmental patterns and user health trends. This leads to a technical problem in that the learning subsystem remains static and fails to adapt to new data distributions, thereby degrading the overall effectiveness and reliability of the prediction functionality as implemented on general-purpose computing hardware.

Accordingly, there is a need for an improved computer-implemented system and processing method in which a processor coordinates communication control, data management, feature generation, prediction execution, and message generation in a unified manner, so that environmental information and personal profile information are efficiently transformed into prediction input data, processed by a learned prediction model, and converted into adaptive warning or advice messages, while also enabling the accumulation and re-use of prediction histories for model retraining. Such an arrangement would improve the functioning of the computer system itself by optimizing data flow, reducing redundant computations, and providing a scalable, extensible architecture for health condition variation prediction and advisory message generation.

The specific processing by the specific processing unit 290 of the data processing device 12 in Example 2 is realized by the following means.

The present invention provides a server comprising a processor and a storage device, the processor being configured to execute communication control software and data management software to acquire, from an external information providing apparatus, environmental information including at least weather, atmospheric pressure, and humidity in a structured data format and to store the environmental information in the storage device; to control an information processing terminal that executes a user application and security software so as to receive user input including at least gender, age, allergy information, and chronic disease information, to cause the terminal to encrypt the user input for transmission, to receive the encrypted personal profile information from the terminal, and to store the personal profile information in the storage device; to execute a data processing program and a numerical computation library to obtain, from the storage device, the environmental information and the personal profile information, to convert the environmental information and the personal profile information into feature values represented as a numerical vector, and to perform preprocessing including at least normalization and encoding to generate prediction input data acceptable to a learned prediction model; to execute a machine learning library implementing the learned prediction model to calculate, from the prediction input data, at least one of a risk index and a risk category indicating a variation in a health condition of a user; to generate a warning message or an advice message including at least a probability of deterioration in the health condition and a recommended action based on at least one of a humidity state and an atmospheric pressure state by using the at least one of the risk index and the risk category and the environmental information; and to transmit, to the information processing terminal, the warning message or the advice message such that display control software executed on the terminal presents the warning message or the advice message on a screen. This enables the computer system to implement an integrated and technically efficient pipeline that securely acquires heterogeneous environmental and profile data, transforms the data into normalized numerical features, performs predictive computation using a trained machine learning model, and generates adaptive, context-aware messages, while reducing redundant processing and improving scalability and accuracy in health condition variation prediction. p The term “system” refers to a combination of hardware and software components, including at least one processor, at least one storage device, and one or more terminals, that cooperate to execute the claimed processes.

The term “processor” refers to any hardware processing unit, such as a central processing unit or a microcontroller, capable of executing instructions of software programs to perform arithmetic, logical, control, and input/output operations.

The term “storage device” refers to any non-transitory computer-readable medium, such as a magnetic storage device, an optical storage device, or a semiconductor memory device, configured to store data and programs used by the processor.

The term “information processing apparatus” refers to a computing device that includes at least one processor and at least one storage device and that executes software for communication control, data management, and data processing.

The term “information processing terminal” refers to a user-operated computing device, such as a smartphone, tablet, or personal computer, which includes a display unit, input unit, processor, and storage device, and which communicates with the information processing apparatus.

The term “external information providing apparatus” refers to a computer system or server operated by a third party that is configured to provide environmental information via a communication network.

The term “communication control software” refers to software executed by the processor to manage communication protocols, establish connections, send and receive data packets, and handle errors over a communication network.

The term “data management software” refers to software, including a database management system or similar component, executed by the processor to store, retrieve, update, and organize structured or semi-structured data in the storage device.

The term “user application” refers to application software executed on the information processing terminal that provides a user interface for inputting, viewing, and managing personal profile information and prediction results.

The term “security software” refers to software components, such as encryption libraries, authentication modules, or key management modules, that are executed to protect data confidentiality, integrity, and authenticity during storage and transmission.

The term “environmental information” refers to information relating to external physical conditions, including at least weather, atmospheric pressure, and humidity, acquired from the external information providing apparatus or sensors.

The term “personal profile information” refers to information that characterizes an individual user, including at least gender, age, allergy information, and chronic disease information, and that is used as input for prediction processing.

The term “allergy information” refers to data indicating whether a user has one or more allergies, and optionally including types or severity levels of such allergies.

The term “chronic disease information” refers to data indicating whether a user has one or more long-term medical conditions, and optionally including types or statuses of such conditions.

The term “structured data format” refers to a representation of data in a predefined format, such as a table or a key-value structure, that allows systematic parsing, indexing, and processing by software.

The term “prediction input data” refers to a representation of combined environmental information and personal profile information that has been transformed into numerical feature values suitable for input to a prediction model.

The term “feature value” refers to a numerical or encoded representation of an attribute derived from raw data, such as an environmental parameter or a personal profile item, which is used as an input dimension of a prediction model.

The term “numerical vector” refers to an ordered collection of numerical values, each value corresponding to a feature, which together serve as a single input sample to a prediction model.

The term “preprocessing” refers to operations applied to raw input data before prediction, including at least normalization and encoding, to transform the data into a standardized numerical format.

The term “normalization” refers to a transformation applied to numerical values, such as scaling or standardizing, to adjust their range or distribution for improved numerical stability and model performance.

The term “encoding” refers to a transformation applied to categorical or symbolic data, such as one-hot encoding or label encoding, to represent such data as numerical values usable by a prediction model.

The term “prediction model” refers to a computational model, implemented in software, that has been trained using machine learning techniques to output a prediction, such as a health risk index or category, based on input features.

The term “learned prediction model” refers to a prediction model whose internal parameters have been trained using historical training data, including past environmental information, personal profile information, and health condition information.

The term “machine learning library” refers to software providing implementations of machine learning algorithms, training routines, and inference functions that can be called by application code executed by the processor.

The term “generative artificial intelligence model” refers to a model, such as a probabilistic model or neural network, that generates natural language text or other content based on an input prompt and learned parameters.

The term “risk index” refers to a numerical value calculated by the prediction model that quantitatively indicates a likelihood or degree of a variation in a user's health condition.

The term “risk category” refers to a discrete classification label, such as low, medium, or high, that indicates a level of risk associated with a variation in a user's health condition.

The term “health condition variation” refers to a predicted change in a user's physical or physiological state, such as worsening of allergy symptoms, onset of headache, or exacerbation of a chronic condition.

The term “warning message” refers to a message that indicates a risk of adverse health condition variation and that may include a description of the risk and recommended cautionary actions.

The term “advice message” refers to a message that provides guidance or recommendations for preventive measures or responses in view of a predicted health condition variation.

The term “recommended action” refers to a suggested behavior, such as taking medication, reducing outdoor activity, or adjusting schedule, presented to a user to mitigate a predicted health risk.

The term “humidity state” refers to a condition or range of atmospheric moisture level, such as high humidity or low humidity, derived from environmental information.

The term “atmospheric pressure state” refers to a condition or range of atmospheric pressure, such as low pressure or rapidly changing pressure, derived from environmental information.

The term “prompt sentence” refers to a text string or sequence of tokens that is provided as input to a generative artificial intelligence model to request generation of an explanation, advice, or other natural language output.

The term “explanation data” refers to data that includes at least one of the risk index and the risk category, environmental information, and personal profile information, and that is used to construct a prompt sentence or to generate explanation content.

The term “prediction result” refers to the output of the prediction model, including at least one of the risk index and the risk category, and optionally associated contextual information.

The term “history” refers to stored records of past prediction results, together with associated environmental information and personal profile information, maintained in the storage device.

The term “retraining” refers to a process in which the prediction model is updated or refined by using additional training data, including the stored histories, to improve prediction performance.

The term “display control software” refers to software executed on the information processing terminal to manage rendering of graphical or textual elements on a display screen, including the presentation of warning messages and advice messages.

The term “screen” refers to a display surface of the information processing terminal, such as a liquid-crystal display or organic light-emitting diode display, on which visual information is presented to a user.

In one embodiment, a server cooperates with one or more terminals to implement a health condition variation prediction system. The server includes at least one processor, volatile and non-volatile memories, a network interface, and a storage subsystem implementing a database. The terminal includes at least one processor, a touch-sensitive display, local memory, a wireless communication interface, and an operating system capable of running an application program.

The server executes operating system software, communication control software, data management software, data processing software, a machine learning library, and, in some embodiments, a client library for accessing a generative AI model through a network. The data management software is implemented, for example, by a relational database management system configured to store environmental information, personal profile information, model parameters, and prediction histories. The machine learning library is implemented, for example, by a general-purpose numerical computation library and a machine learning framework capable of handling matrix operations and gradient-based optimization. The terminal executes an application program providing user interfaces for entering profile data and viewing prediction results, networking libraries for communicating with the server, and graphics libraries for rendering screens.

The server uses its network interface and communication control software to acquire environmental information from an external information provider. The server transmits a network request that includes at least a geographic identifier and an authentication token, and receives a response containing weather-related data such as temperature, humidity, and atmospheric pressure. The server parses a text-based structured representation (for example, a key-value format) and maps fields to internal data structures. The server writes the parsed environmental information into a table in the database, including columns such as region identifier, timestamp, temperature, humidity, atmospheric pressure, and weather condition code. The server maintains indices on region identifier and timestamp, which allows efficient retrieval of the latest conditions for each user region and thereby reduces query latency when generating prediction input data.

The terminal presents, on its display, one or more input screens that allow the user to register and update personal profile information. The terminal runs the application program to render text fields, selection controls, and confirmation buttons through a graphical user interface toolkit. The user touches the screen to input at least gender, age, allergy attributes, and chronic disease attributes. The terminal validates that each required field is present, that numerical fields such as age fall within allowed ranges, and that category selections are consistent. The terminal converts the user inputs into a structured representation, for example a set of key-value pairs, and invokes cryptographic routines to encrypt the payload over a secure transport protocol. The terminal then transmits the encrypted personal profile information to the server.

The server receives the profile information via a network endpoint implemented in application server software. The server authenticates the communication, decodes the structured payload, and validates the values against allowed ranges and enumerations stored in configuration tables. The server normalizes categorical items such as allergy types and chronic disease types by mapping them to internal codes (for example, integers) that are stored in normalized relational tables. The server then writes or updates a user profile record, including foreign-key links to allergy and disease tables, in the database. This normalization enables the server to perform efficient joins and filter operations during feature generation, which results in improved throughput when processing large populations of users.

The server combines environmental information and personal profile information into prediction input data using a feature generation module. The server retrieves the latest environmental record for the region associated with a user by issuing a select query with ordering and limit conditions. The server retrieves the user's profile record and associated allergy and chronic disease codes by executing a join query over the relevant tables. The server then constructs an intermediate feature object that contains raw values such as numeric age, binary flags for each allergy and chronic disease, and continuous environmental measurements including humidity, temperature, and atmospheric pressure.

The server applies preprocessing algorithms to transform the intermediate feature object into a numerical vector. The server uses a numerical computation library to normalize continuous features, for example by subtracting a pre-computed mean and dividing by a pre-computed standard deviation, and to encode categorical features using, for example, one-hot encoding. In one embodiment, the server arranges the resulting feature values in a fixed-length vector with a predetermined ordering of dimensions, which is stored as a one-dimensional array in memory. The server uses vectorized operations to compute normalization across batches of feature vectors, which reduces the number of processor instructions needed per prediction and thereby improves computation speed and energy efficiency compared to scalar processing.

In one embodiment, the server uses a tree-based machine learning model to perform health condition variation prediction. The server loads a pre-trained ensemble model, such as a random forest or gradient boosting model, from storage into memory at startup, and maintains this model in memory for reuse. The server passes each numerical feature vector, or a batch of vectors, to the model's prediction function. The model traverses multiple decision trees for each input, aggregating the outputs into a risk score in the range from 0 to 1 representing, for example, a probability of symptom worsening. The server compares the risk score against configurable thresholds to assign a risk category such as low, medium, or high. Because the feature vectors are normalized and structured, and the model is loaded once and reused, the server reduces prediction latency and improves prediction throughput under high user load.

In another embodiment, the server uses a neural network architecture as the learned prediction model. The server constructs a feed-forward network comprising an input layer receiving the feature vector, one or more hidden layers with fully connected units and non-linear activation functions, and an output layer producing either a continuous risk score or discrete risk probabilities. The server trains the network offline using historical environmental data, historical profile data, and historical health condition labels collected from users. The server uses a loss function such as cross-entropy for classification tasks or mean squared error for regression tasks, and applies gradient-based optimization with backpropagation to update network weights. The server may apply regularization techniques, such as dropout or L2 weight penalties, and may augment the training data by introducing small perturbations in environmental values to improve robustness against sensor noise and fluctuations. By explicitly defining the network architecture, feature representation, and training procedure, the system improves prediction accuracy and stability over simple rule-based approaches and can adapt to complex, non-linear relationships between environmental factors and health outcomes.

The server updates the learned prediction model using stored histories. The server logs, in a dedicated prediction history table, each prediction event with the corresponding feature vector, timestamp, region identifier, risk index, risk category, and, when available, ground-truth feedback such as a user-reported symptom event. The server uses these histories to periodically retrain the prediction model, either on the same computing system or on a separate training system. The retraining process includes re-computing normalization statistics, re-estimating model parameters, and updating thresholds used to map scores to categories. When the updated model satisfies validation criteria such as reduced error rate on a validation dataset or improved calibration of probabilities, the server deploys the updated parameters to the production environment. As a result, the prediction pipeline continuously adapts to new data distributions and improves its performance over time, which is a technical effect not achievable by static, manually coded rules.

The server generates messages based on the prediction result and environmental context. The server uses a message generation module that contains predefined templates and logic rules. The server selects a template according to the risk category and the type of conditions contributing most strongly to the risk, such as high humidity or low atmospheric pressure. The server fills in placeholders in the template with actual values, for example, specific humidity percentages or pressure levels, and includes recommended actions determined from mapping tables that associate risk conditions with advice items. The server outputs a text string that the terminal can render directly without further processing, reducing terminal-side computation and ensuring consistency of messaging.

In an embodiment leveraging a generative AI model, the server constructs a prompt sentence that summarizes the user's profile, current environmental conditions, and computed risk. The server may, for example, assemble the following prompt sentence:
“The server has predicted a high risk of health condition change for a 35-year-old female user with pollen allergy and asthma, based on current weather data: temperature 28 degrees Celsius, humidity 85 percent, and low atmospheric pressure, retrieved from a weather information service. Please generate a concise, user-friendly advisory message that explains why the risk is high and recommends specific preventive actions the user can take today. The output should be in English and limited to three short paragraphs.”

The server sends the prompt sentence to a generative AI model interface over a network. The generative AI model executes on separate computational resources, using a large neural network with multiple attention layers and embedding layers to transform the prompt into a sequence of token probabilities and generate natural language text that explains the predicted risk. The server receives the generated text, optionally applies filtering or truncation rules, and combines it with the structured risk category into a final message. Because the server uses structured prediction outputs and feature attribution information to guide prompt construction, the generated messages can include specific causal explanations and concrete recommendations, enabling more informative guidance while still leveraging the deterministic risk calculation from the learned model.

The terminal receives the message and displays it on the screen. The terminal's application program parses the message payload delivered by the server and configures visual components accordingly. When the risk category is high, the terminal changes color schemes, shows warning icons, and may trigger accessibility features such as vibration or sound alerts. The user can read the warning or advice, and can optionally open a detailed view that displays contributing environmental factors and suggested actions. By rendering the messages in a structured layout, the terminal allows rapid comprehension, reducing the cognitive burden on the user.

The server optimizes data flows and communication patterns to improve technical performance. The server batches prediction requests, when possible, to compute predictions for multiple users in a single call to the learned model, thereby using vectorized matrix operations and reducing per-request overhead. The server caches recent environmental records per region in memory, which avoids repeated database access for users located in the same region within a short time window. The server compresses selected network responses and minimizes the size of the message payloads by transmitting compact identifiers where appropriate. These measures reduce communication load on the network and decrease end-to-end response times.

The server applies internal rules and non-conventional processing steps that are not simple automations of human tasks. For example, the server computes feature importance scores or sensitivity measures within the model (such as gradients of the risk index with respect to environmental variables) and uses these scores to decide which conditions to highlight in messages. The server may employ a rule that, when multiple risk factors are present, selects the factor with the largest contribution score as the primary explanation. This algorithmic strategy is based on the internal structure and parameters of the trained model and would not arise from traditional human judgment alone. Additionally, the server can dynamically adjust thresholds for risk categories using historical calibration curves stored in the database, thereby maintaining target false positive and false negative rates under changing data distributions.

In alternative embodiments, the server uses different model architectures and feature sets while preserving the same overall data and processing structures. In one variation, the server uses a recurrent neural network or a sequence model to process time-series sequences of environmental data to capture trends such as rapid pressure drops. The server includes as features not only current values but also moving averages, differences, and trend indicators over preceding time windows. In another variation, the server uses a convolutional network over temporal windows to detect patterns of environmental fluctuations that correlate with symptom onset. These architectures operate on data structures that are explicitly stored and indexed in the database, and the server generates sequences or windows through database queries optimized with time-based indices.

The system as described provides technical improvements beyond abstract data processing. By structuring environmental and profile data into normalized tables with indices, by converting heterogeneous information into standardized numerical vectors, by applying trained models that exploit non-linear relationships, and by caching and batching operations, the server improves processing throughput, reduces computational redundancy, and enhances prediction accuracy. These improvements manifest in measurable performance gains, such as reduced average prediction latency, higher accuracy of risk categorization as quantified by objective metrics, more stable operation under heavy concurrent load, and reduced network traffic between server and terminals. Therefore, the use of computer hardware and AI models in this system is not a mere automation of human reasoning, but a specific arrangement of data structures, algorithms, and hardware cooperation that improves the functioning of the computer system itself.

In practical use, the user installs the application on the terminal, registers profile information once, and then periodically consults the system before engaging in outdoor activities or strenuous tasks. The server continuously acquires and refines environmental and prediction data and updates models based on accumulated histories. Over time, as the server adapts its model parameters and thresholds using stored prediction histories and ground-truth feedback, the system provides increasingly precise and timely warnings. This continuous technical adaptation is enabled by the described data management and machine learning subsystems and demonstrates a concrete, technologically grounded implementation of health condition variation prediction using a server-terminal architecture and generative AI-assisted messaging.

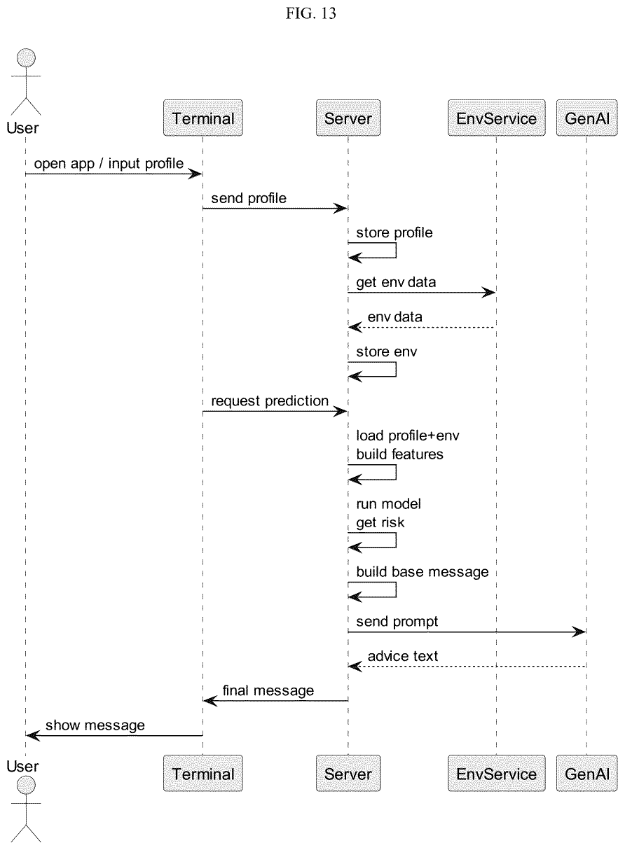

The following describes the processing flow using FIG. 13.

### Step 1:

The server acquires environmental information from an external information provider.

The server uses communication control software to send a network request that includes a region identifier and authentication data as input.

The server receives a structured response containing raw environmental data, including at least temperature, humidity, and atmospheric pressure, as output.

The server parses the structured response, maps each field (for example, temperature, humidity, pressure, timestamp, region code) into an internal data structure, and writes these values into a database table.

The server performs data processing by converting text fields to numeric types, normalizing units if necessary, and storing the processed values with indices on region and timestamp to support efficient retrieval.

### Step 2:

The terminal collects personal profile information from the user.

The terminal displays input forms on the screen and accepts, as input, user-entered values including gender, age, allergy items, and chronic disease items.

The terminal performs validation on the input, such as checking that age is numeric and within allowed bounds, and that required fields are not empty.

The terminal serializes the validated data into a structured representation, encrypts the representation using security software, and outputs an encrypted payload.

The terminal transmits the encrypted payload over a secure communication channel to the server.

### Step 3:

The server receives and stores personal profile information.

The server takes, as input, the encrypted payload from the terminal via a network endpoint. The server authenticates the request, decrypts the payload if needed, and parses the structured representation to extract fields such as gender, age, allergy codes, and chronic disease codes. The server performs data processing by mapping free-form selections to standardized internal codes, enforcing referential integrity with master tables, and rejecting invalid or unknown codes.

The server outputs normalized profile records and stores them in relational tables in the database, associating each record with a unique user identifier.

### Step 4:

The server prepares combined feature data for prediction.

The server receives, as input, a prediction request from the terminal that includes a user identifier and optionally a region identifier.

The server queries the database for the latest environmental record for the specified region and for the stored profile record associated with the user identifier.

The server combines the retrieved environmental information and profile information into an intermediate feature object containing raw numeric values (for example, age, humidity, pressure) and categorical identifiers (for example, gender code, allergy codes, chronic disease codes).

The server outputs the intermediate feature object as the basis for numerical feature generation.

### Step 5:

The server converts combined data into a numerical feature vector.

The server takes, as input, the intermediate feature object generated in Step 4.

The server applies preprocessing algorithms: the server normalizes continuous attributes (for example, temperature, humidity, pressure, age) using pre-computed mean and standard deviation, and encodes categorical attributes (for example, gender, allergy type, chronic disease type) using one-hot encoding or similar techniques.

The server executes these operations using vectorized functions of a numerical computation library, thus computing multiple normalized and encoded values in a single batch operation. The server outputs a fixed-length numerical feature vector, in which each dimension corresponds to a specific normalized or encoded attribute, and stores this vector in memory for input to the prediction model.

### Step 6:

The server performs health condition variation prediction using a learned model.

The server takes, as input, the numerical feature vector from Step 5.

The server supplies the feature vector to a learned prediction model, such as a tree-based ensemble or a neural network, implemented by a machine learning library.

The server executes the model's prediction function, which performs internal computations such as traversing decision trees or multiplying the feature vector by weight matrices and applying non-linear activation functions.

The server calculates, as output, at least one of a risk index (for example, a probability value) and a risk category (for example, low, medium, high) representing a predicted variation in the user's health condition.

The server may apply post-processing such as thresholding or calibration to map the raw model output to the final risk index and risk category.

### Step 7:

The server generates a structured warning or advice message based on the prediction result.

The server uses, as input, the risk index and/or risk category from Step 6, together with the environmental information and profile information used in the prediction.

The server applies message generation rules to select a message template appropriate for the risk category and the dominant contributing factors (for example, high humidity for allergy risk, low pressure for headache risk).

The server fills in parameters of the selected template with values such as current humidity percentage, pressure level, and relevant allergy or chronic disease labels.

The server outputs a structured message string that includes at least a textual warning or advice and, optionally, additional detail fields such as recommended actions or explanations.

### Step 8:

The server optionally refines the message using a generative AI model.

The server constructs, as input, a prompt sentence that summarizes the user's profile, current environmental conditions, and calculated risk, for example:
“The server has predicted a high risk of health condition change for a 35-year-old female user with pollen allergy and asthma, based on current weather data: temperature 28 degrees Celsius, humidity 85 percent, and low atmospheric pressure, retrieved from a weather information service. Please generate a concise, user-friendly advisory message that explains why the risk is high and recommends specific preventive actions the user can take today. The output should be in English and limited to three short paragraphs.”

The server sends the prompt sentence to a generative AI model interface and receives, as output, a natural-language explanation or advice text.

The server combines the generated text with the structured message from Step 7, for example by inserting the generated explanation into a designated section of the response.

The server outputs a final message that incorporates both deterministic risk information and context-aware natural-language guidance.

### Step 9:

The terminal retrieves and displays the prediction result to the user.

The terminal sends, as input to the server, a request for the latest prediction and message for the current user identifier.

The terminal receives, as output from the server, the final message and associated metadata (for example, risk category).

The terminal parses the received data, updates visual components such as text labels, icons, and color schemes, and renders the warning or advice message on the screen using display control software.

The terminal may trigger additional behaviors, such as vibration or alert sounds, when the risk category indicates a high level of concern.

### Step 10:

The user reviews the advice and optionally provides feedback.

The user reads, as input, the warning or advice message displayed on the terminal.

The user may adjust behavior in the real world (for example, preparing medication, avoiding outdoor activity) based on the displayed content.

The user may optionally input feedback, such as confirming whether symptoms actually occurred, through the terminal's application interface.

The terminal sends the feedback to the server, which stores the feedback in the prediction history tables as output for later use in model evaluation and retraining.

### Step 11:

The server records prediction histories and updates training data.

The server takes, as input, each prediction result from Step 6, together with the associated feature vector, environmental values, profile data, and any user feedback from Step 10.

The server writes this combined information into prediction history tables in the database, including timestamps and identifiers.

The server periodically retrieves batches of history records, constructs training datasets by assembling feature vectors and corresponding target labels (for example, whether actual symptoms were reported), and computes updated model parameters using a training algorithm.

The server outputs updated model files or parameter sets, which replace the previous model used in

Step 6, thereby improving future prediction accuracy and stability.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented health support systems typically treat data acquisition, health prediction, and advice generation as separate and narrowly specialized functions. Environment information such as weather, pressure, and humidity is often acquired by a dedicated program; user attribute information such as age and allergy is read by another module; and emotion information such as facial expression or voice tone is handled, if at all, by an independent analytics component. As a result, these systems are generally configured as static pipelines with fixed rule sets and model interfaces.

Because these conventional architectures hard-code the data flow and processing logic for each data source and each analytic model, they suffer from several technical problems. First, the integration of heterogeneous data sources requires extensive custom code and rigid interface definitions between modules. Any extension of input dimensions (for example, adding new sensor types or new emotion indicators) demands code changes, redeployment, and in many cases system downtime. Second, the interaction between the prediction module and downstream advisory modules is commonly limited to simple scalar parameters, which does not allow the advisory logic to fully exploit the rich context of environment information, attribute information, and emotion information. Third, systems that attempt to incorporate generative AI models often treat such models as mere “black box” text generators, without a structured, machine-controlled mechanism to construct prompts and orchestrate end-to-end processing. This results in non-deterministic behavior, inconsistent quality of generated outputs, increased latency due to ad hoc string handling, and difficulty in auditing and improving the overall system.

Moreover, existing systems do not provide a uniform, computer-controlled layer for dynamically generating prompt sentences that drive external components, such as data acquisition apparatuses, storage services, analytic models, and generative AI models. Without such a layer, the processor cannot systematically adapt its acquisition and processing behavior at run time in response to changing user states or environmental conditions. This lack of a unified prompt-generation mechanism causes inefficiencies in computing resource utilization, increases coupling between modules, and makes it difficult to tune or optimize the behavior of machine-learning pipelines as new types of models and services are introduced. Therefore, there is a need for an improved computer-implemented technique that (i) unifies the control of environment information acquisition, attribute information acquisition, emotion recognition, feature generation, prediction, and advice generation, (ii) utilizes a processor-driven prompt sentence layer as a machine-readable and machine-writable control interface, and (iii) technically improves the way in which a generative AI model is integrated into the end-to-end health prediction and recommendation workflow. Such a technique should reduce integration complexity, increase flexibility for extending input data and model types, improve the consistency and auditability of generative outputs, and enhance the efficiency of health-related computation on a server that serves multiple user terminals in real time.

The specific processing by the specific processing unit 290 of the data processing device 12 in Application Example 2 is realized by the following means.

The present invention provides a server comprising a processor and a memory storing instructions that, when executed by the processor, cause the processor to generate, as an environment information acquisition process, a prompt sentence configured to cause an acquisition apparatus or an information providing apparatus to acquire a plurality of types of surrounding environment information including at least one of weather information, pressure information, and humidity information; generate, as an attribute information acquisition process, a prompt sentence configured to cause a storage apparatus to provide user attribute information stored in the storage apparatus, the user attribute information including at least one of demographic information, allergy information, and chronic condition information; generate, as an emotion information acquisition process, a prompt sentence configured to cause an image capturing apparatus and an audio capturing apparatus to provide user-related media data and to cause an analysis of the media data to recognize an emotional state of a user; generate, as a feature generation process, a prompt sentence configured to cause generation of health-related feature data on the basis of the surrounding environment information, the user attribute information, and the emotional state; generate, as a prediction process, a prompt sentence configured to cause a generative AI model or another machine-learning model to predict a fluctuation of a health condition using the health-related feature data as input; and generate, as an advice information generation process, a prompt sentence configured to cause the generative AI model or another information processing model to generate behavior guideline information including at least one of intake proposal information and settlement proposal information or to generate guidance information for an in-facility information processing apparatus, on the basis of the fluctuation of the health condition, the surrounding environment information, the user attribute information, and the emotional state. This enables the server to implement a unified, prompt-driven control layer that orchestrates heterogeneous data acquisition, feature computation, prediction, and generative advice in a technically efficient and extensible manner, thereby improving the computer-implemented processing architecture for health condition prediction and recommendation, enhancing scalability and adaptability when integrating new sensors and models, and increasing consistency, auditability, and responsiveness of outputs generated by the generative AI model.

The term “processor” refers to a hardware or virtual processing unit, such as a central processing unit or an execution core, that executes instructions to perform information processing operations.

The term “memory” refers to any computer-readable storage medium, including volatile or non-volatile storage, that stores instructions and data for access by the processor.

The term “system” refers to an arrangement including at least a processor and one or more apparatuses or services that cooperate to execute the processes defined in the claims.

The term “environment information acquisition process” refers to a processing operation in which a prompt sentence is generated to cause another apparatus or service to acquire surrounding environment information.

The term “surrounding environment information” refers to information representing conditions external to a user, including at least one of weather information, atmospheric pressure information, humidity information, temperature information, and related physical condition information.

The term “acquisition apparatus” refers to any sensor device or data collecting device configured to obtain surrounding environment information, such as a physical sensor module or an external data source interface.

The term “information providing apparatus” refers to any information source device or service, such as a remote information service, configured to supply surrounding environment information in response to a request.

The term “attribute information acquisition process” refers to a processing operation in which a prompt sentence is generated to cause a storage apparatus to provide user attribute information stored in the storage apparatus.

The term “storage apparatus” refers to any data storage system, database system, or storage service that retains user-related information and can return such information in response to access requests.

The term “user attribute information” refers to information that characterizes a user, including at least one of demographic information, health-related background information, allergy information, and chronic condition information.

The term “emotion information acquisition process” refers to a processing operation in which a prompt sentence is generated to cause capture and analysis of media data associated with a user in order to recognize an emotional state of the user.

The term “image capturing apparatus” refers to any imaging device, such as a camera or visual sensor, configured to capture image data including a user's appearance or facial expression.

The term “audio capturing apparatus” refers to any sound acquisition device, such as a microphone or audio sensor, configured to capture audio data including a user's voice.

The term “media data” refers to data representing at least one of image information, video information, and audio information associated with a user.

The term “emotional state” refers to information indicating a psychological or affective condition of a user, such as joy, stress, sadness, neutrality, or discomfort, inferred from analysis of media data or textual input.

The term “feature generation process” refers to a processing operation in which a prompt sentence is generated to cause computation of health-related feature data based on surrounding environment information, user attribute information, and an emotional state.

The term “health-related feature data” refers to a set of derived values, vectors, or descriptors that encode characteristics of a user's potential health condition, constructed from multiple types of input information.

The term “prediction process” refers to a processing operation in which a prompt sentence is generated to cause execution of a model that predicts a fluctuation of a health condition using health-related feature data as input.

The term “fluctuation of a health condition” refers to a predicted change or tendency in a user's physical or physiological state over time or under given conditions, such as an increase or decrease in risk of symptoms.

The term “generative AI model” refers to a machine-implemented information processing model that, in response to an input including a prompt sentence, generates output information such as text, numerical data, or structured content.

The term “advice information generation process” refers to a processing operation in which a prompt sentence is generated to cause creation of behavior guideline information or guidance information based on a predicted fluctuation of a health condition and associated context information.

The term “behavior guideline information” refers to information recommending one or more user actions or behaviors, such as lifestyle actions, intake actions, or financial actions, suitable for a predicted health condition.

The term “intake proposal information” refers to behavior guideline information that proposes contents or patterns of ingestion of items, including at least one of meal contents, food combinations, and beverage selections.

The term “settlement proposal information” refers to behavior guideline information that proposes one or more transaction settlement options, including at least one of payment methods and settlement flows, adapted to a user state.

The term “guidance information” refers to information intended to be displayed on an information processing apparatus in a facility to guide an operator or staff member in providing a service to a user.

The term “in-facility information processing apparatus” refers to any information processing device installed in a physical facility, such as a store terminal or a staff workstation, that displays guidance information for in-person service.

The term “face-to-face service contents” refers to contents of a service provided directly and physically by a human operator to a user, including at least one of product proposals, assistance actions, and in-person support actions.

The term “prompt sentence” refers to a machine-generated instruction expression, represented as text or structured data, that describes an operation to be executed by another apparatus, service, or model, including but not limited to acquisition of information, analysis of data, prediction processing, or generation of advice.

In one embodiment, a server cooperates with one or more terminals operated by users to implement the claimed system. The server includes a processor, a memory, a network interface, and access to one or more storage apparatuses such as a relational database system and a file storage system. The terminals include a processor, a memory, a display, an image capturing apparatus, an audio capturing apparatus, and a network interface. The server executes a program that controls environment information acquisition, user attribute information acquisition, emotion recognition, feature generation, prediction, and advice generation by generating and handling prompt sentences as machine-readable control instructions.

The server stores in the memory a set of software modules including: an environment information controller, an attribute information controller, an emotion analysis controller, a feature generation engine, a prediction engine, an advice generation engine, a prompt management module, and a communication module. The server also stores or accesses one or more machine-learning models, including a discriminative prediction model implemented, for example, by a random forest classifier or a gradient boosting tree model, and a generative AI model implemented, for example, by a transformer-based neural network.

The server uses the environment information controller to obtain surrounding environment information from external acquisition apparatuses and information providing apparatuses. For example, the server may send HTTP requests via the network interface to a remote weather information service that provides structured data representing weather, atmospheric pressure, and humidity for a given geographic area. The server parses responses encoded in a structured data format and normalizes the values into an internal environment record. In another embodiment, the server sends control messages to physical sensors, such as a temperature sensor, a barometric pressure sensor, and a humidity sensor deployed in a facility, and receives time-stamped measurements as numerical values.

The server uses the attribute information controller to obtain user attribute information from a storage apparatus such as a user profile database. The server accesses tables that contain demographic information, allergy information, and chronic condition information. The server converts the retrieved records into an internal attribute vector that uses normalized numerical and categorical encodings rather than raw text. For example, the server maps gender into a one-hot encoded vector, age into a normalized scalar, and each allergy category into a binary indicator in a fixed-length vector.

The terminal presents user interfaces that allow a user to register and update attribute information. The terminal accepts textual input and selection of options for items such as age, gender, presence of allergies, and presence of chronic diseases. The terminal transmits the entered information to the server, which validates and stores the information in the storage apparatus. The server therefore maintains an up-to-date attribute information set for each user.

The terminal uses the image capturing apparatus and the audio capturing apparatus to capture media data for emotion analysis. The terminal acquires a sequence of image frames including the user's face and an audio waveform including the user's voice. The terminal transmits the captured media data to the server over a network connection. In an alternative embodiment, the terminal performs part of the emotion analysis locally and transmits intermediate features to the server.

The server uses the emotion analysis controller to recognize an emotional state from the media data. The server applies an image processing library such as a general-purpose computer vision library to detect facial regions in the image frames. The server then resizes crop regions to a fixed spatial resolution and normalizes pixel intensities. The server feeds these preprocessed images into a convolutional neural network (CNN) model implemented in a machine-learning framework. The CNN model includes multiple convolutional layers with rectified linear unit activation, pooling layers, and fully connected layers that output a probability distribution over emotion classes such as joy, stress, sadness, and neutrality. The server aggregates probabilities across frames and selects a dominant emotion class according to a defined rule, such as an argmax over the average probabilities.

The server optionally converts the audio waveform into a text transcription using a speech-to-text service and applies a natural language processing library to detect sentiment and symptom expressions from the text. The server integrates visual emotion features, audio-derived features, and text sentiment into a single emotional state representation by using a weighted averaging rule or a small feed-forward neural network trained on labeled emotion data. The emotional state representation is stored in the storage apparatus and associated with the corresponding user and time.

The server uses the feature generation engine to produce health-related feature data. The server retrieves, for a given user, the current surrounding environment information, the user attribute information, and the emotional state representation. The server applies a deterministic transformation that maps these values into a fixed-dimension feature vector. The transformation may include scaling numerical values to zero-mean unit-variance, encoding categorical variables via one-hot encoding, and concatenating a real-valued emotion embedding vector produced by the emotion analysis controller. The server may also compute engineered features such as interaction terms between humidity and allergy status or between emotional state and chronic condition status. By standardizing the feature generation process, the server ensures that the prediction engine receives data in a format optimized for numerical computation, which improves numerical stability and facilitates vectorized processing.

The server uses the prediction engine to estimate a fluctuation of a health condition on the basis of the health-related feature data. In one embodiment, the prediction engine uses a random forest classifier implemented in a general-purpose machine-learning library. The server loads the trained random forest model into memory and passes the feature vector as input. The model consists of multiple decision trees, each constructed by recursively partitioning the feature space according to impurity reduction criteria during training. The server obtains per-tree votes and aggregates them into a probability distribution over output classes such as “condition likely to worsen,” “condition stable,” and “condition likely to improve.” In another embodiment, the prediction engine uses a multi-layer perceptron neural network that maps the feature vector to a continuous risk score using dense layers and nonlinear activation functions.

The server trains the prediction model offline using a plurality of historical records that include environment information, attribute information, emotional states, and observed health outcomes. During training, the server minimizes a loss function such as cross-entropy loss for classification or mean squared error for regression. The server uses an optimization algorithm such as stochastic gradient descent or its variants to update model parameters. The server may apply data augmentation techniques, such as random perturbation of environment variables within realistic ranges, to improve generalization. The server may also perform hyperparameter tuning using cross-validation to select the number of trees in the random forest, tree depth, learning rate of neural networks, and other parameters.

The server uses the advice generation engine to construct prompt sentences and to obtain behavior guideline information and guidance information from the generative AI model. The generative AI model is, in one embodiment, a transformer-based language model with multiple self-attention layers and feed-forward layers. The model receives text prompts that encode context and instructions and generates text sequences token by token. The server does not rely on free-form user-written prompts; instead, the server programmatically composes prompt sentences using structured templates and current context values. This controlled prompt generation process ensures that the generative AI model operates within clear constraints and produces outputs that can be interpreted and used by downstream modules. The server generates, for example, a prompt sentence for health advice as follows:
“Environment: cold weather, 5 degrees Celsius, pressure 1005 hPa, humidity 40 percent.

User: 35-year-old female, no allergies, no chronic disease.

Emotion: stressed.

Prediction: higher risk of fatigue and feeling cold today.

Based on this information, generate clear and practical health advice for the user.”

The server sends this prompt sentence to the generative AI model through an API interface and receives a textual response that includes health advice. The server may post-process the output by applying filters, truncation, and language normalization.

The server also generates prompt sentences for meal recommendation, such as:
“Current weather is cold (5 degrees Celsius) and dry (humidity 40 percent).

The user is a 35-year-old female with no food allergies or chronic diseases.

The user feels stressed and the predicted body condition is ‘easily gets cold and fatigued.’

As a nutrition expert, propose a one-day meal menu (breakfast, lunch, dinner) with specific dish names and brief explanations, focusing on warming and easy-to-digest foods.”

The server uses the generative AI model to obtain a structured meal proposal and converts the output into internal data structures that specify meal types, dish names, and descriptions. The server stores this data and transmits relevant parts to the terminal for display.

The server further generates prompt sentences for payment and promotion suggestions, for example:
“The user is checking out in a mobile shopping app.

Profile: 30-year-old male.

Emotion: stressed (detected from facial expression and voice).

Goal: minimize cognitive load and interaction steps.

Suggest the best payment method (for example, quick one-tap, credit card, installment) and an optional promotion (for example, small discount or loyalty points) that will make the experience smooth and reassuring.

Return a short explanation suitable for display on a smartphone screen.”

The server obtains from the generative AI model a recommendation and an explanation, maps the recommendation to actual payment options supported by the system, and sends the information to the terminal.

The terminal displays to the user, on the display apparatus, the predicted fluctuation of the health condition, the health advice, the meal recommendation, and any payment or promotion suggestion. The terminal may present separate views or sections such as “Today's Condition,” “Recommended Actions,” “Meal Menu,” and “Checkout Options.” The user can read the generated information and optionally provide feedback regarding whether the advice was helpful or accurate. The terminal transmits the feedback to the server, which stores it in association with the corresponding feature data and model outputs.

In another embodiment related to in-facility guidance, the server receives facial images captured by a terminal installed in a physical facility, such as a store or clinic. The server applies the same emotion recognition processing to infer an emotional state. The server combines the emotional state with local environment information and stored user attribute information, and predicts the user's health condition fluctuation. The server then generates a prompt sentence such as:
“Today's weather is sunny.

The customer in the facility is smiling, as detected by an emotion-recognition model.

The customer has no allergy and no chronic disease in the facility's profile database.

Predict the customer's body condition and recommend what kind of in-facility service or product tasting the staff should propose.”

The server obtains guidance information from the generative AI model and sends concise staff-facing messages to a staff-side terminal. The staff-side terminal displays these messages so that staff can adjust in-person service content.

The server thereby does more than merely automate human decision-making; the server introduces a technical prompt-driven orchestration layer that standardizes and optimizes interaction between multiple heterogeneous components: sensors, databases, discriminative models, and a generative AI model. By constructing and managing prompt sentences as explicit machine-generated control structures, the server can modify system behavior dynamically without recompiling core logic, can support additional sensors and model types through standardized templates, and can enforce consistent context encoding for all calls to the generative AI model. This reduces integration complexity, allows parallel and batched calls to external services, and enables caching and reuse of certain prompts and responses, thereby improving processing throughput and reducing network load.

The server also improves prediction accuracy and stability by integrating environment information, attribute information, and emotional state into a unified feature representation that is not readily available to a human decision-maker. The server can handle high-dimensional feature vectors with precise numerical scaling and can execute prediction models with deterministic latency. The combination of a structured feature pipeline and model optimization produces lower error rates in predicting health condition fluctuations compared to rule-based systems or systems that rely on a single data modality. The system configuration provides technical effects in terms of processing speed, accuracy, data management, and communication efficiency. The server can precompute feature vectors and partially precompute prompts for frequently occurring conditions, which reduces response time when terminals request up-to-date predictions. The server can store prompts and responses along with metadata for audit and reuse, improving data management and maintenance. By using structured prompts that include explicit context fields, the server can minimize unnecessary exchanges with the generative AI model and can restrict updates to specific portions of the prompt when context changes, which reduces communication overhead.

The server uses non-conventional rules and procedures in constructing and interpreting prompt sentences. For example, the server enforces a specific field order and labeling convention within each prompt, includes key numerical values with units, and encodes internal model states such as risk scores into textual descriptions in a standardized way. This specialized encoding enables the generative AI model to produce more stable and predictable outputs than it would under free-form prompting. The server also uses feedback from users to adjust prompt templates and weighting of features, which forms an adaptive control loop that improves system performance over time.

In another embodiment, the server employs a different neural network architecture for the prediction engine, such as a recurrent neural network or a temporal convolutional network that takes as input a time series of past feature vectors. This allows the system to capture temporal patterns in environment changes and health outcomes, further improving predictive performance. The training process uses a sequence loss function and back-propagation through time, and the server periodically retrains the model with accumulated data.

In yet another embodiment, the terminal performs a portion of the feature generation or emotion recognition, such as running a lightweight facial expression classifier locally and sending only class probabilities to the server. This reduces the amount of media data transmitted over the network, thereby decreasing communication load and improving privacy. The server still applies the same prompt-driven orchestration to coordinate the remaining processing, including prediction and generative advice.

By designing the system around prompt sentences as explicit, structured control instructions between components, the server enhances the internal operation of the computer system. The arrangement of modules, the definition of feature vectors, and the use of specific machine-learning architectures and training procedures collectively improve the performance, scalability, and robustness of health condition prediction and recommendation processing, beyond the capabilities of mere human mental steps or conventional manual workflows.

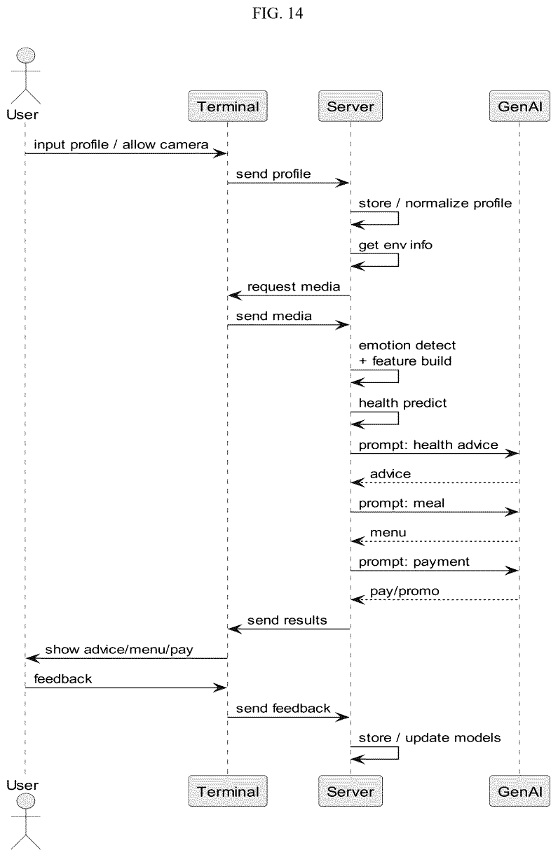

The following describes the processing flow using FIG. 14.

### Step 1:

Server initializes internal modules and loads models.

Server receives, as input, configuration data indicating model file locations, database connection parameters, and prompt templates.

Server loads, into memory, a prediction model (for example, a random forest or neural network) and initializes a client for a generative AI model API.

Server loads prompt sentence templates for environment acquisition, attribute acquisition, emotion acquisition, feature generation, prediction, and advice generation, and stores them in an internal template registry.

Server outputs initialized module states and model handles that are ready for subsequent processing.

### Step 2:

Terminal acquires and sends user profile input.

Terminal receives, as input, user-entered data such as age, gender, allergy status, and chronic condition status via a graphical user interface.

Terminal validates the input (for example, confirming that age is numeric and mandatory fields are not empty) and converts the input into a structured record with standardized field names.

Terminal sends the structured profile record to the server over a secure network connection.

Terminal outputs a formatted profile message addressed to the server.

### Step 3:

Server stores and normalizes user attribute information.

Server receives, as input, the structured profile record from the terminal.

Server writes the profile fields into a user profile table in a storage apparatus, assigning or confirming a unique user identifier.

Server converts raw text fields into normalized internal representations, such as mapping gender to codes and allergies to binary flags.

Server outputs a normalized user attribute vector associated with the user identifier.

### Step 4:

Server acquires surrounding environment information.

Server receives, as input, a request to update environment information for a particular user or region, including a location identifier.

Server constructs a prompt sentence instructing an acquisition apparatus or information providing apparatus to provide weather, pressure, and humidity for the specified location.

Server sends a corresponding request to an external environment information source and receives numerical and categorical environment values.

Server parses and normalizes those values into an environment feature record and outputs this environment feature record linked to the user identifier.

### Step 5:

Terminal captures user media data for emotion analysis.

Terminal receives, as input, a command from the server or local application logic to capture media data.

Terminal activates an image capturing apparatus and an audio capturing apparatus, and records a sequence of facial images and a segment of voice audio while the user interacts with the terminal.

Terminal compresses the media data and bundles it with metadata such as timestamps and the user identifier.

Terminal outputs the bundled media data packet and transmits it to the server.

### Step 6:

Server detects facial regions and extracts visual emotion features.

Server receives, as input, the media data packet containing image frames.

Server applies a face detection algorithm to each frame, crops detected face regions, and resizes them to a fixed resolution.

Server feeds the preprocessed facial images into a convolutional neural network and computes, for each image, a probability distribution over emotion classes.

Server aggregates the per-frame probabilities into a single set of visual emotion scores and outputs a visual emotion feature vector.

### Step 7:

Server analyzes audio and text for additional emotion cues.

Server receives, as input, the audio component of the media data packet and any text entered by the user.

Server converts the audio into a text transcription using a speech-to-text function and combines it with explicit user text input.

Server applies a natural language processing model to the combined text to detect sentiment polarity and symptom-related phrases.

Server converts the sentiment and symptom findings into numeric features and outputs an audio-text emotion feature vector.

### Step 8:

Server integrates multi-modal emotion features into an emotional state.

Server receives, as input, the visual emotion feature vector and the audio-text emotion feature vector.

Server applies a predefined weighting rule or a small neural network to combine the features and compute a unified emotional state representation.

Server determines a dominant emotional state label (for example, “stressed” or “joyful”) and an associated confidence score.

Server outputs the emotional state label and an emotional state feature vector.

### Step 9:

Server constructs a health-related feature vector.

Server receives, as input, the normalized user attribute vector, the environment feature record, and the emotional state feature vector.

Server scales numerical values using stored mean and variance, encodes categorical values using one-hot or similar encoding, and concatenates all features into a fixed-length array.

Server optionally computes interaction features, such as the product of humidity level and allergy flag, and appends them to the feature array.

Server outputs a complete health-related feature vector suitable for numerical prediction.

### Step 10:

Server predicts fluctuation of a health condition.

Server receives, as input, the health-related feature vector.

Server passes the feature vector into the prediction model and performs the model's inference computation, such as traversing decision trees or propagating values through neural network layers.

Server obtains a predicted class or continuous risk score representing a likely change in the user's health condition, and interprets the output according to thresholds and rules.

Server outputs a structured prediction result including a label (for example, “likely to worsen”), a numerical risk score, and timestamp information.

### Step 11:

Server constructs a prompt sentence for health advice.

Server receives, as input, the environment feature record, the user attribute vector, the emotional state label, and the prediction result.

Server fills a predefined health-advice template by inserting concrete values such as weather conditions, age, allergy presence, emotional state, and risk score into placeholder fields.

Server generates a natural-language prompt sentence that instructs the generative AI model to produce specific and practical health advice.

Server outputs the completed prompt sentence ready for submission to the generative AI model.

### Step 12:

Server obtains health advice from the generative AI model.

Server receives, as input, the health-advice prompt sentence.

Server sends the prompt sentence to the generative AI model interface and triggers text generation based on the encoded context.

Server receives a textual response that contains one or more recommendations regarding lifestyle, precautions, or symptom management.

Server outputs a processed health-advice text after removing extraneous segments and ensuring it conforms to display constraints.

### Step 13:

Server constructs a prompt sentence for meal recommendation.

Server receives, as input, the same environment, attribute, emotional, and prediction data used for health advice, and optionally diet preference data.

Server composes a meal-focused prompt sentence that describes conditions and instructs the generative AI model to output a structured proposal for intake contents.

Server explicitly requests meal times, dish names, and short explanations, while reflecting constraints derived from allergies and health risks.

Server outputs a meal-recommendation prompt sentence.

### Step 14:

Server obtains a meal proposal from the generative AI model.

Server receives, as input, the meal-recommendation prompt sentence.

Server submits the prompt sentence to the generative AI model and executes a generation operation that produces text containing a daily meal plan.

Server parses the returned text, detects meal sections such as breakfast, lunch, and dinner, and extracts dish names and descriptions.

Server outputs a structured meal recommendation data set.

### Step 15:

Server constructs a prompt sentence for payment and promotion suggestion.

Server receives, as input, the emotional state label, the prediction result, and transaction context information indicating that the user is at a checkout stage.

Server encodes these parameters into a text description and fills a template that instructs the generative AI model to select an appropriate payment method and promotion strategy.

Server ensures that the prompt sentence requests a concise explanation tailored for display on a terminal.

Server outputs a payment-and-promotion prompt sentence.

### Step 16:

Server obtains payment and promotion recommendations.

Server receives, as input, the payment-and-promotion prompt sentence.

Server sends the prompt sentence to the generative AI model and receives a response describing a recommended payment method and any suggested promotion.

Server maps the textual description of the recommendation to system-supported payment methods using a predefined mapping table.

Server outputs a recommendation object containing a method identifier, a promotion message, and explanatory text.

### Step 17:

Server consolidates outputs and sends results to the terminal.

Server receives, as input, the prediction result, health-advice text, structured meal recommendation, and payment-and-promotion recommendation.

Server assembles these elements into a single response record with clearly labeled sections.

Server serializes the record into a format suitable for transmission and sends it to the terminal over the network.

Server outputs a completed response message containing all current recommendations for the user.

### Step 18:

Terminal displays prediction and recommendations to the user.

Terminal receives, as input, the response message from the server.

Terminal parses the message into logical sections and populates user interface elements, such as panels or tabs, with the prediction, advice text, meal menu, and payment suggestion.

Terminal renders the content on the display, using icons, colors, and layout to highlight important information such as high-risk conditions or recommended quick payment options.

Terminal outputs visual and, optionally, audio feedback that the user can perceive and act upon.

### Step 19:

User reviews information and optionally provides feedback.

User receives, as input, the displayed prediction, advice, meal suggestions, and payment options.

User may select, on the terminal, indicators such as “useful” or “not accurate,” rate individual recommendations, or enter free-form comments.

User completes the interaction by confirming or rejecting proposed actions, such as selecting a meal or a payment method.

User outputs feedback selections and choices through the terminal's input interface.

### Step 20:

Terminal transmits user feedback and choices to the server.

Terminal receives, as input, the user's ratings, comments, and selected actions.

Terminal packages the feedback and action data with associated identifiers for the prediction instance and session.

Terminal sends this package to the server, confirming any transactional choices such as chosen payment method or accepted promotion.

Terminal outputs a feedback message and update request directed to the server.

### Step 21:

Server stores feedback and updates models or prompt templates over time.

Server receives, as input, the feedback message and any transaction confirmations from the terminal.

Server writes the feedback into a feedback repository, linking it with the corresponding feature vector, prediction result, and generated texts.

Server periodically analyzes accumulated feedback to adjust model parameters or to refine prompt sentence templates, for example, by modifying phrasing or adding constraints that have historically improved user satisfaction.

Server outputs updated model configurations and revised prompt templates that enhance future prediction and recommendation performance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

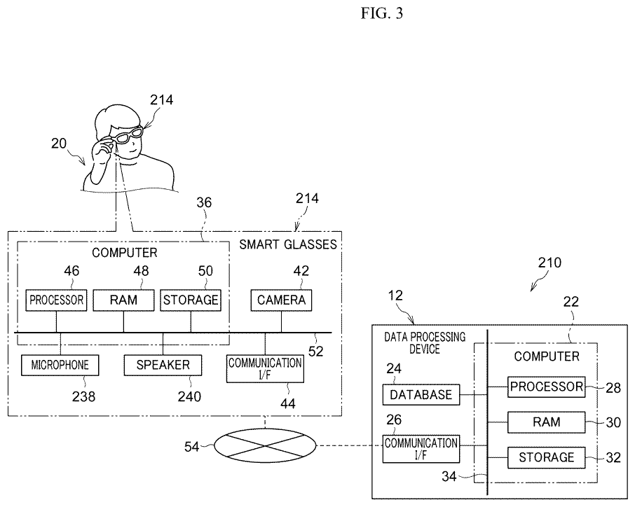

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

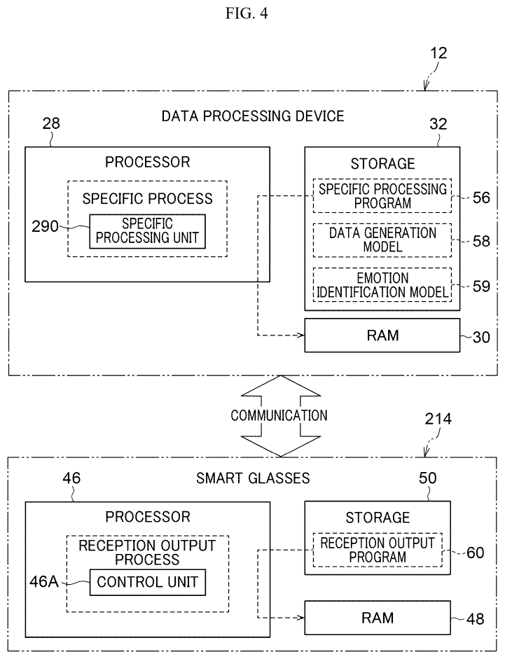

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

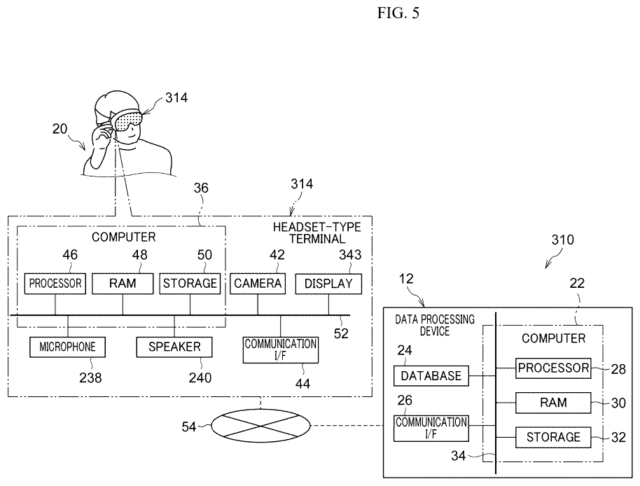

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

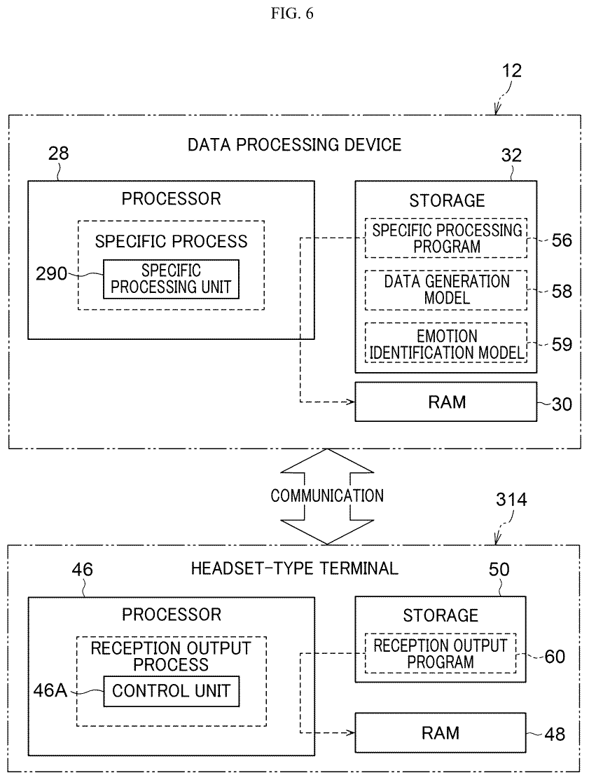

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

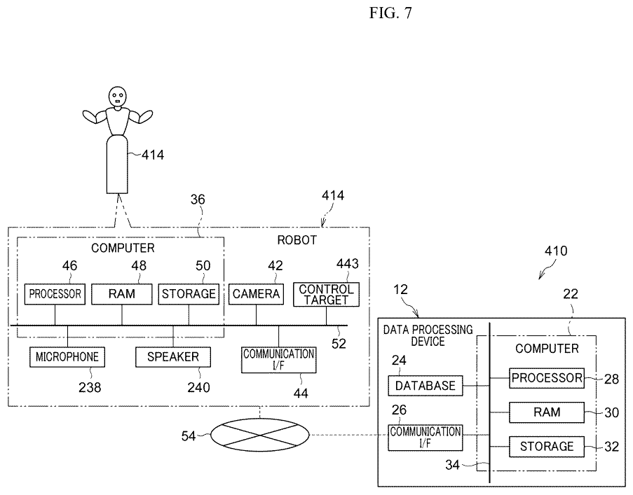

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

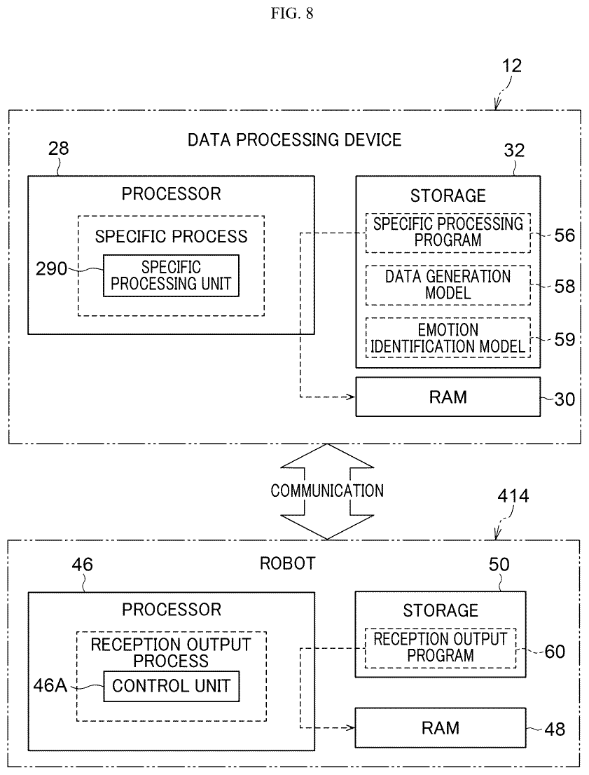

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

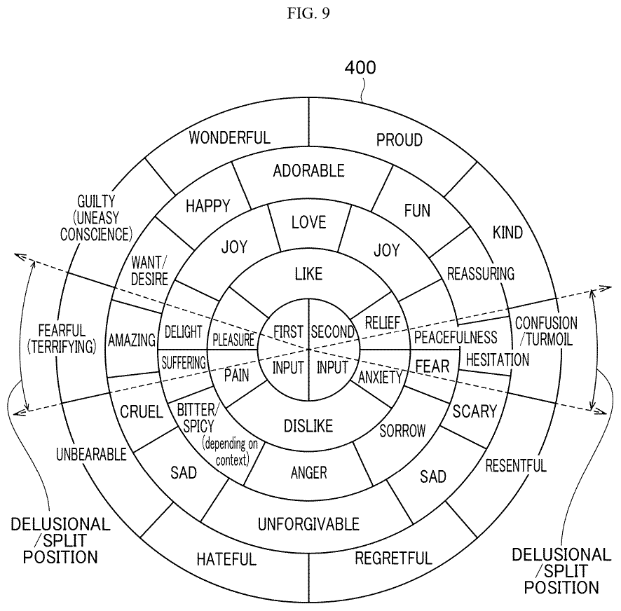

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

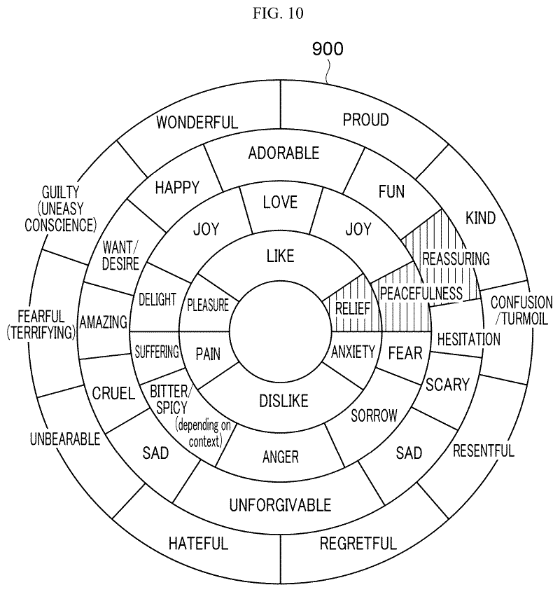

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
collect environment information by using an information acquisition unit, and
acquire user attribute information by using an information acquisition unit, and
acquire emotional state information by using an information acquisition unit, and
hold a prediction model for calculating health state variation information based on the environment information and the user attribute information, convert the environment information and the user attribute information into numerical values as feature quantities to generate a feature vector to be input to the prediction model, and estimate the health state variation information by using the feature vector, and
generate a prompt sentence to be input to a generative information processing model based on the health state variation information and the emotional state information, input the prompt sentence to the generative information processing model, and cause the generative information processing model to generate explanation information and advice information in natural language, and
output the health state variation information, the explanation information, and the advice information to a user terminal, and
store evaluation information acquired from the user terminal in association with the health state variation information, and update the prediction model by using the evaluation information.

### Supplementary 2

The system according to supplementary 1,
wherein the processor is configured to
dynamically construct the prompt sentence to be input to the generative information processing model based on symptom type information, risk level information, contributing factor information, and time information included in the health state variation information, and age information, gender information, and disease information included in the user attribute information, and perform post-processing on a natural language response obtained from the generative information processing model in accordance with content and expression format to be displayed on the user terminal.

### Supplementary 3

The system according to supplementary 1,
wherein the processor is configured to
acquire, as the evaluation information, user evaluation information regarding usefulness of the explanation information and the advice information and user evaluation information regarding prediction accuracy of the health state variation information, generate a training data set for the prediction model by using the user evaluation information, and re-train parameters of the prediction model based on the training data set.

### Application Example 1

### Supplementary 1

A system comprising a processor,
wherein the processor is configured to
generate instruction information to start an acquisition process of environmental information by a sensing resource, acquire the environmental information including at least weather information, pressure information, and humidity information via a communication path or a detection resource based on the instruction information, and store the environmental information in a structured data format in a storage resource,
generate instruction information to start an acquisition process of user attribute information stored in a storage resource, acquire the user attribute information including at least gender information, age information, allergy information, and medical condition information based on the instruction information, and store the user attribute information in association with identification information in the storage resource,
generate instruction information to start a collection process of facial expression information and voice information of a user by an imaging resource and an audio acquisition resource, acquire the facial expression information and the voice information based on the instruction information, and execute a recognition process on the facial expression information and the voice information to identify an emotional state of the user,
generate a feature set based on the environmental information and the user attribute information, provide input data including the feature set and the emotional state to a machine learning model, and execute a computation process to calculate prediction information regarding a biological state variation of the user,
generate description text including constraint conditions and preference conditions relating to nutrient intake based on the prediction information regarding the biological state variation and the user attribute information, and create a prompt sentence including the description text,
input the prompt sentence to a generative artificial intelligence model, obtain meal candidate information from the generative artificial intelligence model, analyze the meal candidate information to generate meal proposal information including a plurality of meal options and respective main components in a structured format, and transmit the meal proposal information to a display terminal, and
generate presentation control information to cause the display terminal that has received the meal proposal information to visually present the meal options in a selectable form to the user.

### Supplementary 2

The system according to supplementary 1,
wherein the processor is configured to
dynamically change content of the prompt sentence based on the prediction information regarding the biological state variation and user behavior history information stored in the storage resource, and execute a control process to adjust a detail level or constraint conditions of the meal candidate information obtained from the generative artificial intelligence model.

### Supplementary 3

The system according to supplementary 1,
wherein the processor is configured to
include summary information of the prediction information regarding the biological state variation in at least a part of the meal proposal information, provide the meal proposal information including the summary information to the display terminal, and execute a presentation control process to cause the display terminal to present the summary information together with the meal options.

### Example 2

### Supplementary 1

A system comprising a processor,
wherein the processor is configured to acquire environmental information by executing communication control software and data analysis software on an information processing apparatus to receive, in a structured data format, environmental information including at least weather, atmospheric pressure, and humidity from an external information providing apparatus, and to store the environmental information in a storage device by using data management software,
acquire personal profile information by causing an information processing terminal, on which a user application and security software are executed, to receive user input including at least gender, age, allergy information, and chronic disease information, encrypt the personal profile information for transmission over a communication path, transmit the encrypted personal profile information to the information processing apparatus, and store the personal profile information in the storage device by using the data management software, generate prediction input data by executing a data processing program and a numerical computation library on the information processing apparatus to obtain the environmental information and the personal profile information from the storage device, convert the environmental information and the personal profile information into feature values represented as a numerical vector, and perform preprocessing including at least normalization and encoding so as to generate prediction input data acceptable to a generative artificial intelligence model,
perform health condition variation prediction by using, on the information processing apparatus, a learned prediction model implemented by a machine learning library to calculate, from the prediction input data, at least one of a risk index and a risk category indicating a variation in a health condition of the user,
generate a message by using the at least one of the risk index and the risk category and the environmental information to generate a warning message or an advice message including at least a probability of deterioration in the health condition and a recommended action based on at least one of a humidity state and an atmospheric pressure state, and
present a result by causing the information processing terminal, on which display control software is executed, to display the warning message or the advice message on a screen.

### Supplementary 2

The system according to supplementary 1,
wherein the processor is configured to
generate the message by generating, based on explanation data including the at least one of the risk index and the risk category, the environmental information, and the personal profile information, a prompt sentence for the generative artificial intelligence model, and by using a natural language explanation or advice, obtained from the generative artificial intelligence model in response to the prompt sentence, as at least a part of the warning message or the advice message.

### Supplementary 3

The system according to supplementary 1,
wherein the processor is configured to
perform the health condition variation prediction by using, as the learned prediction model, a machine learning model trained on past environmental information, past personal profile information, and past health condition information stored in the storage device, and to additionally store, in the storage device, prediction results of the health condition variation prediction as history to be usable as training data for retraining the machine learning model.

### Application Example 2

### Supplementary 1

A system comprising a processor,
wherein the processor is configured to
generate, as an environment information acquisition process, a prompt sentence for causing an acquisition apparatus or an information providing apparatus to acquire a plurality of types of surrounding environment information,
generate, as an attribute information acquisition process, a prompt sentence for causing a storage apparatus to provide user attribute information stored therein,
generate, as an emotion information acquisition process, a prompt sentence for causing an image capturing apparatus and an audio capturing apparatus to provide user-related media data and for causing an analysis of the media data to recognize an emotional state of a user, generate, as a feature generation process, a prompt sentence for causing generation of health-related feature data on the basis of the surrounding environment information, the user attribute information, and the emotional state,
generate, as a prediction process, a prompt sentence for causing a generative AI model to predict a fluctuation of a health condition using the health-related feature data as input, and generate, as an advice information generation process, a prompt sentence for causing generation of behavior guideline information in accordance with the fluctuation of the health condition.

### Supplementary 2

The system according to supplementary 1,
wherein the processor is configured to
generate, in the advice information generation process, a prompt sentence for causing the generative AI model to generate proposal information regarding intake contents and proposal information regarding settlement means on the basis of the fluctuation of the health condition, the surrounding environment information, the user attribute information, and the emotional state.

### Supplementary 3

The system according to supplementary 1,
wherein the processor is configured to
generate, in the advice information generation process, a prompt sentence for causing the generative AI model to generate guidance information to be displayed on an in-facility information processing apparatus on the basis of the fluctuation of the health condition, the surrounding environment information, the user attribute information, and the emotional state, and for causing determination of face-to-face service contents on the basis of the guidance information.

What is claimed is:

1. A system comprising:
circuitry configured to:
receive, via a communication interface coupled to a packet-switched network, first sensor data representing environmental conditions, second data representing user attribute information, and third data representing an estimated state of a user from a terminal device, and store the received data in a storage device;
convert the first sensor data and the second data into numerical feature quantities and generate a feature vector from the numerical feature quantities;
input the feature vector into a prediction model stored in a memory to compute state variation information representing a predicted change in user state, the state variation information comprising at least a state type indicator, a risk level value, a contributing factor set, and a time-horizon value;
construct a prompt sentence based on the state variation information and the third data, input the prompt sentence to a generative model via the communication interface, and receive explanation data and recommendation data expressed in natural language from the generative model; and
transmit the state variation information, the explanation data, and the recommendation data to the terminal device via the communication interface, receive evaluation data from the terminal device in association with the state variation information, and update the prediction model using the evaluation data.

2. The system according to claim 1, wherein the first sensor data comprises at least atmospheric pressure data, temperature data, and humidity data, and wherein converting the first sensor data into numerical feature quantities comprises normalizing each sensor data element to a range between zero and one based on a respective minimum and maximum value stored in the storage device.

3. The system according to claim 2, wherein the second data comprises at least an age value, a gender code, an allergy indicator, and a chronic condition indicator, and wherein converting the second data into numerical feature quantities comprises applying a respective encoding scheme to each categorical attribute and a respective scaling function to each numerical attribute.

4. The system according to claim 1, wherein the state type indicator, the risk level value, the contributing factor set, and the time-horizon value are extracted from an output tensor of the prediction model, and wherein constructing the prompt sentence comprises formatting the extracted values into a structured prompt template that also incorporates contextual information from the third data.

5. The system according to claim 4, wherein the structured prompt template specifies an output format for the explanation data and the recommendation data, and wherein performing post-processing on the natural language response from the generative model comprises parsing the response according to the specified output format and extracting the explanation data and the recommendation data as separate fields.

6. The system according to claim 1, wherein updating the prediction model using the evaluation data comprises performing incremental learning on the prediction model by computing a loss value based on the evaluation data and the previously computed state variation information, and adjusting weight parameters of the prediction model based on the computed loss value.

7. The system according to claim 6, wherein the circuitry is configured to accumulate a plurality of evaluation data items in the storage device before updating the prediction model, and to trigger the incremental learning when the accumulated plurality exceeds an update threshold.

8. The system according to claim 1, wherein the third data representing the estimated state of the user is determined by the circuitry from audio data or image data received from the terminal device using a state estimation model stored in the memory, and wherein the state estimation model outputs a state category label and a confidence score.

9. The system according to claim 8, wherein the circuitry is configured to adjust the recommendation data output to the terminal device based on the state category label, such that a first output format is applied when the state category label indicates a first state category and a second output format is applied when the state category label indicates a second state category.

10. The system according to claim 1, wherein the circuitry is configured to retrieve historical state variation information stored in the storage device in association with the user identification information, compute a trend value based on the historical state variation information and the current state variation information, and incorporate the trend value into the prompt sentence as an additional context parameter.

11. The system according to claim 10, wherein the trend value represents a rate of change of the risk level value over a preceding time window, and wherein incorporating the trend value into the prompt sentence comprises inserting the trend value together with a trend direction label into a designated field of the structured prompt template.

12. The system according to claim 1, wherein the circuitry is configured to generate, based on the state variation information, a notification message and transmit the notification message to the terminal device when the risk level value exceeds a risk threshold stored in the storage device.

13. The system according to claim 12, wherein the notification message is generated by constructing a notification prompt sentence incorporating the state variation information and a severity indicator derived from the risk level value, inputting the notification prompt sentence to the generative model, and extracting the notification message from a response returned by the generative model.

14. The system according to claim 1, wherein the circuitry is configured to receive, together with the evaluation data, a corrective action record indicating an action taken by the user in response to the recommendation data, store the corrective action record in the storage device in association with the state variation information, and incorporate a plurality of stored corrective action records as training labels when updating the prediction model.

15. The system according to claim 14, wherein the circuitry is configured to compute a recommendation effectiveness score based on a correspondence between the corrective action record and the recommendation data, and to update a recommendation weight table stored in the storage device based on the recommendation effectiveness score.

16. The system according to claim 1, wherein the prediction model is a machine learning model trained to output a multi-dimensional output vector from the feature vector, and wherein the multi-dimensional output vector encodes the state type indicator as a class probability distribution, the risk level value as a scalar, the contributing factor set as a binary attribution vector, and the time-horizon value as a regression output.

17. The system according to claim 16, wherein the feature vector is constructed by concatenating the numerical feature quantities derived from the first sensor data and the second data, and augmenting the concatenated vector with a temporal encoding representing a time of day and a day of week at which the first sensor data was acquired.

18. A system comprising:
circuitry configured to:
receive, via a communication interface coupled to a packet-switched network, first sensor data representing environmental conditions, second data representing user attribute information, and third data representing an estimated state of a user from a terminal device;
convert the first sensor data and the second data into numerical feature quantities, generate a feature vector, and input the feature vector into a prediction model stored in a memory to compute state variation information comprising a state type indicator, a risk level value, a contributing factor set, and a time-horizon value;
construct a prompt sentence based on the state variation information and the third data, transmit the prompt sentence to a generative model via the communication interface, and receive explanation data and recommendation data from the generative model; and
transmit the state variation information, the explanation data, and the recommendation data to the terminal device via the communication interface, and update the prediction model based on evaluation data received from the terminal device.

19. The system according to claim 18, wherein the circuitry is configured to store the evaluation data in a storage device in association with the state variation information, compute a loss value based on the evaluation data and the computed state variation information, and adjust weight parameters of the prediction model based on the computed loss value.

20. A method comprising:
receiving, via a communication interface coupled to a packet-switched network, first sensor data representing environmental conditions, second data representing user attribute information, and third data representing an estimated state of a user from a terminal device, and storing the received data in a storage device;
converting the first sensor data and the second data into numerical feature quantities and generating a feature vector from the numerical feature quantities;
inputting the feature vector into a prediction model stored in a memory to compute state variation information representing a predicted change in user state, the state variation information comprising at least a state type indicator, a risk level value, a contributing factor set, and a time-horizon value;
constructing a prompt sentence based on the state variation information and the third data, inputting the prompt sentence to a generative model via the communication interface, and receiving explanation data and recommendation data expressed in natural language from the generative model; and
transmitting the state variation information, the explanation data, and the recommendation data to the terminal device via the communication interface, receiving evaluation data from the terminal device in association with the state variation information, and updating the prediction model using the evaluation data.
